(19) United States
(12) Patent Application Publication
(10) Pub. No.: US 2005/0239542 A1
(43) Pub. Date: Oct. 27, 2005

(54) Method and apparatus for multi-coin and multi-denomination progressive jackpots

(76) Inventor: Eric B. Olsen, Hendersen, NV (US)

Correspondence Address: Morishita Law Firm, L.L.C.;Suite 102, 2725 S. Jones Blvd., Las Vegas, NV, 89146, US

(21) Appl. No.: 10/957,820

(22) Filed: Oct. 4, 2004

Related U.S. Application Data
(60) Provisional application No. 60/564,192, filed on Apr. 21, 2004.

(51) Int. Cl. G06F 17/00; G06F 19/00

(52) U.S. Cl. 463/27

(57) ABSTRACT

The present invention is a method for controlling the funding and awarding of jackpot awards in a game in which wagers of varying size and/or denomination may be placed for conduct of the game and, during play of the game, a progressive payout trigger may occur. The method includes establishing a plurality of virtual progressive pools, each of which is correlated to a wager level. Upon receipt of a wager, a contribution, optionally an allocation of a wager, is made to virtual progressive pools for the wager level of the wager and at least one lesser wager level, if any. Upon a progressive payout trigger, a progressive award is issued that represents the sum of the virtual pools to which a contribution was made. Optionally the virtual pools included in the progressive award are reset to a base value.

### RELATED APPLICATION DATA

The present application claims the priority of U.S. Provisional Application Ser. No. 60/564,192, entitled “Method and Apparatus for Multi-Coin and Multi-Denomination Progressive Jackpots,” filed Apr. 21, 2004 by Applicant herein.

### FIELD OF THE INVENTION

A general method and apparatus for progressive awards on electronic gaming machines which support multi-coin wagers and multi-denomination wagers.

### BACKGROUND OF THE INVENTION

The emergence of multi-denomination gaming devices is quickly changing the nature of gaming in casinos. In particular, multi-denomination gaming devices complicate the issue of offering progressive jackpots. It is anticipated that multi-denomination games will continue to grow in number.

Multi-coin, fixed denomination games have been in use for many years in casinos. However, consideration of how prior art progressive jackpots are offered on traditional coin multiplier games uncovers a long-standing inequity. This inequity has an advantage for the casino in that it creates an incentive for players to place maximum size wagers. The present invention addresses this inequity while maintaining the critically important incentive. In so doing, a general method is conceived that provides a general, flexible, yet fair method of handling progressive jackpots on gaming devices that support both multi-coin and multi-denomination wagers.

The emergence of multi-denomination gaming devices has complicated the issue of offering progressive jackpots on these games. While there have been several implementations of progressive awards offered on multi-denomination games, most methods have either offered separate jackpots per denomination type, or have introduced significant modifications which make such methods limited in application, or non-practical altogether.

Up to now, methods of offering progressive jackpots on multi-denomination games have created significant limitations. For example, in one prior art example of a multi-denomination progressive link, the underlying games must have the probability of hitting the jackpot adjusted in proportion to the size of the wager denomination. In other words, the underlying games of this prior art example no longer have an equivalent probability of hitting the jackpot. This intentional change is required to justify the fact that different denominations of game play are being linked to the same jackpot pool. However, this change can also be deceptive, since many players may not realize the chance of hitting the progressive is smaller when a smaller denomination is used.

Another long-standing issue with prior progressive jackpots is when multi-coin games are used. Most multi-coin games are often referred to as “coin multiplier” games. In a coin multiplier game, single coin pay-outs (for non progressive awards) are multiplied by the number of coins wagered. For example, if a particular winning combination pays 10 coins when a single coin is wagered, that same winning combination will pay 20 coins if two coins are wagered, and so on.

In the prior art, coin multiplier games are often used when linking games to form a progressive jackpot. In most cases, the progressive jackpot is not available to players who wager anything other than the maximum coin wager. (The maximum coin wager is the greatest number of coins supported for each given wager) This is viewed as an advantage to the casino, since it provides incentive for the player to place a maximum coin wager. In many of these implementations, a portion of each wager is allocated to the progressive jackpot, without regard to wager size. Therefore, the player wagering anything less than the maximum coin wager contributes to the progressive jackpot, even though the player is not eligible to win the progressive jackpot. This raises a question of the fairness of a conventional progressive system. This question has caused regulators in some jurisdictions to outlaw this method of funding and awarding progressive jackpots. One way prior art systems have responded is to fund contributions to the progressive jackpot from maximum coin wagers only.

Equally important is communicating to the player how the progressive game works. In prior art, i.e. fixed denomination, progressive systems, players easily understand that a progressive award is offered in lieu of a standard payout of the underlying gaming device. However, if the presentation of a progressive system is not clear, or too complicated to understand, it may not be accepted in the marketplace.

Of greatest importance is that the progressive jackpot entices players to play the underlying game. Prior art progressive systems on fixed denomination games have done this, but with the fairness problem noted earlier. Furthermore, the progressive jackpot should entice players to wager more than they might normally wager if there was no progressive. This additional incentive is important to the casino, and the game manufacturer.

Other drawbacks to the prior art include: some methods for solving the problem divide the coin wager by all possible outcomes, and track multiple awards for each situation, thereby dividing the overall contribution and making the ultimate progressive payout for a given number of machines very slow moving. In other words, such systems fail to capitalize on group contributions.

Background of Standard Prior Art Progressive System

It is helpful to review a typical prior art progressive system to illustrate basic principals and help define terms. In FIG. 1, a plurality of electronic gaming machines (EGM) 100 are linked together through a communications network 200. A progressive controller 300 is also linked to network 200, and allows communication between each machine 100 and the progressive controller 300. The progressive controller 300 may be a dedicated standalone unit, or can be a software process or server unit within a larger slot accounting and player tracking system. Generally, the progressive controller 300 will drive an overhead display unit 400, which serves to display progressive information to all players and potential players. The progressive controller 300 may also drive individual displays within each machine, also known as “in-machine” displays 500, or alternatively send information to each EGM allowing them to drive their own in-machine displays, or to allow each EGM to display the progressive value(s) on its video screen. The latter method is sometimes referred to as “on screen display” of the progressive amount(s).

FIG. 1B shows an alternate example embodiment of a prior art progressive system. The progressive system of FIG. 1B shows a “system approach”, using conventional PC's, and conventional network technology, such as TCP/IP over Ethernet. In such an embodiment, the progressive controller may be a software process executing on server 310. In such case, the server is capable of handling multiple progressive jackpot links, shown as Group A 810, Group B 820 and Group N 830 in FIG. 1B. A configuration and control workstation 800 is also part of a network 200, allowing the progressive system to be configured and managed. Progressive jackpot display 400 connects to network 200 and receives progressive jackpot data from server 310. Electronic gaming machines (EGM), such as EGM 100, typically support a network address, and are capable of being addressed by progressive server 310. EGMs 100 communicate via network 200 to establish all required communications for progressive link operation. FIG. 1B also demonstrates a simplified diagram for Internet gaming, if each EGM 100 is replaced by a PC being used to play the underlying game and progressive link.

In FIG. 1C, another alternate prior art embodiment is shown. In FIG. 1C, a plurality of dedicated progressive controllers 300 & 320 are used in lieu of a server-based progressive controller 310 of FIG. 1B. In this case, the dedicated progressive controllers contain their own CPU and software or firmware to implement required progressing for each link, or link(s).

FIGS. 1, 1B and 1C illustrate basic concepts of the prior art, and are not meant to describe detailed options and methods for purposes of illustration. It is known, however, that the prior art methods and systems have been applied in many different environments. For example, a progressive link can be applied to table games, and apparatus used for such purpose is known in the art.

Basic Terms

Regardless of the hardware and software embodiments, there are several terms used within the prior art to describe a progressive award system.

The “progressive jackpot pool” is created by adding monetary contributions from each machine included within the progressive link. The term “progressive link” refers to the group of gaming machines contributing to a specific progressive prize, regardless of the physical hardware, or physical links. The term originated in earlier times when a physical link and progressive link were the same, however, due to advanced communications and computer networks, this is no longer so limited.

The progressive jackpot is the amount of the progressive pool at any given instant. Since all machines within a progressive link contribute to the same progressive award, the progressive amount typically increases as players play. The progressive jackpot is typically awarded to the player that first satisfies the winning game combination associated with the jackpot. In many cases, progressive jackpots are associated with the least probable winning combination and are commonly the highest paying award of the gaming device. The process of winning the progressive jackpot is often referred to as “hitting” the progressive jackpot.

Note that more than one progressive jackpot may be configured within a single progressive link; these different progressive jackpots are referred to as “progressive levels”, or “progressive groups”. Each progressive level may be associated with a different game combination, or pay level of the machine.

Typical Prior Art Progressive Link

Again referring to FIG. 1, and by means of example, a single group progressive system of the prior art is depicted. The system is referred to as single group, because only one payline combination of the underlying EGM 100 is associated to a progressive prize, or progressive jackpot award 600. In a typical practical example, the EGM 100 supports a fixed number of coins for each wager; in this example we will use three coins maximum per wager, i.e., the max coin is therefore equal to 3 coins. Again, in most typical cases, the progressive jackpot is offered only to those wagering max coins, which is 3 in this example. However, all wagers will increment the progressive jackpot, usually using the same rate regardless of wager size.

Consider a player wagering only a single coin on EGM 100 in FIG. 1. Also assume that the coins are dollar denomination, and that the progressive increment rate is 1%. Therefore, for each single coin wager made, a total of $0.01 (one cent) will be contributed, or added to, the progressive jackpot. Let's assume the progressive jackpot has just been started, and that the starting amount for the progressive, or base value as it is referred to herein, is $1000.00 even. Progressive jackpot display 400 will therefore display this amount prior to any wagers being made.

If the player of the example makes the very first single coin wager, the value of the progressive jackpot will incrementally increase to $1000.01. The EGM 100 in this case communicates the wager information to progressive controller 300. The progressive controller 300 applies the progressive increment rate to the wager information, and adds the resulting contribution to an on-going jackpot pool amount.

The new jackpot pool amount 600 is then displayed on the overhead progressive display 400.

Note however, that the player is never eligible to win the jackpot since the player is not playing max coin. Consider another player, Player B, playing EGM 101 in FIG. 1. This player is wagering two coins at once. In this case, player B contributes 1% of 2 dollars, or two cents ($0.02) to the jackpot pool per wager. If Player B is the second player to make a wager, the progressive jackpot pool will be $1000.03, since two cents is added to the prior amount of $1000.01.

Consider a third player, player C, wagering max coin on EGM 102. Player C is still contributing a flat 1% to the progressive pool, which is a total of 3 cents in this case, since three dollars is being wagered. Therefore, for each wager size, a fixed percentage is accumulated to the progressive pool, regardless of size of wager. However, player C is eligible to hit the progressive jackpot. For example, if player C made the third wager on the system, the progressive jackpot would increment by 3 cents to a total value of $1000.06. If that wager then resulted in a progressive jackpot, player C would earn $1000.06 instead of the base pay amount of $1000.00. In many cases, much larger values would accumulate before a player hits the progressive jackpot because of the typically low probability of a winning combination.

If player C hits the progressive jackpot, the value of the jackpot is reset. In this example, we established a base pay value of $1000.00. Therefore, in a typical instance, $1000.00 is re-established as the jackpot award. In FIG. 1, progressive controller 300 tracks each jackpot group, therefore, $1000.00 is stored back into the memory location used to track the progressive jackpot value. This is referred to as a “jackpot reset”. The value for the jackpot reset can be programmed in the controller 300 using a workstation 800 running the progressive configuration utility program, for example. Furthermore, the increment rate, expressed as a percentage, or as a fixed amount per coin wagered, is also generally stored within the progressive controller 300, and set using a configuration utility.

As basic requirements for a progressive system, a base value, an increment rate, and a jackpot value need to be stored and managed appropriately by the progressive jackpot controller. In FIG. 1C, all such elements are illustrated for a basic progressive controller function. Progressive controller 300 includes a data communications process 325 for communicating to the EGMs and displays. When wager information is received, the progressive link wager processing unit 340 applies the value of each wager received to an increment rate 345 to create a progressive contribution to be accumulated into the jackpot pool 350. If a winning jackpot message is received, jackpot award processing unit 360 awards the winner with the value contained in the jackpot pool 350. The process 360 also resets the jackpot pool 350 by copying the reset value 355 into the jackpot pool 350.

It should be noted that the increment rate 345, the jackpot pool 350, and the reset value 355, are basic elements for each progressive group tracked by the prior art controller 300, and each progressive link tracked by the controller. The wager processor unit 340 and the jackpot award process 360 may or may not be copied for each instance of a progressive jackpot, since this is related to the choice of embodiment, such as the embodiments shown in FIGS. 1, 1B and 1C. For example, a progressive controller may be configured to handle two groups within one link. In this case, there are two jackpot pools that will be managed by the progressive controller. Therefore, two jackpot pools, JP0 and JP1, must be tracked, and such information stored into memory of the controller.

In some prior art systems, the amount contributed to the progressive jackpot is made as a straight percentage of the amount wagered, and that contribution is made irregardless of the whether there is one coin bet, two coins bet, or any number of coins bet per wager. It is of some significance to note that prior art systems may perform this function in different ways, such as adding a fixed monetary amount to the progressive jackpot for each coin wagered, for example. However, it is a significant point that in prior art systems, a single progressive pool is tracked and contributed to for each associated progressive jackpot group. Typically, a fixed increment percentage, or fixed increment per coin wagered, of each wager is made to the jackpot pool. Otherwise, a fixed percentage of only eligible wagers can fund the pool if jurisdictions outlaw collecting contributions from ineligible wagers.

### SUMMARY OF THE INVENTION

The present invention is a method for controlling the funding and awarding of jackpot awards in a game in which varying wagers may be placed for conduct of the game and, during play of the game, a progressive payout trigger may occur. In one optional embodiment, directed to control of one or more progressive jackpot pools, the game includes generating a plurality of game outcomes, at least one of which results in a progressive payout trigger. Two or more wager levels are defined. Wager level could be defined in any way, but in one optional embodiment, wager level is a coin multiple level, and in another optional embodiment, wager level is a wager denomination level. Optionally, a finite number of wager levels are defined with a terminal wager level representing the smallest wager level allocating a greater portion of the wager to the progressive pool than any other wager level.

The progressive jackpot pool or pools are subdivided into two or more virtual progressive pools and each virtual progressive pool is associated with a wager level. A wager is received for play of the game and at least a portion of the wager is allocated to the virtual progressive pool associated to the wager level of the wager and at least a portion of the wager is allocated to at least one virtual progressive pool associated with a lesser wager level, if any. The allocation could optionally vary with the wager level. In a further optional embodiment, a multiple is defined for each wager level and the contribution to each virtual pool is proportional to the multiplier. In response to the progressive payout trigger, a progressive award is issued. The progressive award is equal to the sum of the virtual progressive pools associated with the wager level and each lesser wager level, if any, to which the wager placed at the time of the progressive payout trigger was allocated. In such an optional embodiment, each progressive jackpot pool may be associated to a specific winning game outcome and, optionally, the progressive payout trigger may be unique for each winning game outcome, the progressive payout trigger being actuated during play of a game resulting in a winning game outcome associated with the wager level. After issuing a progressive award, each virtual progressive pool is reset to a base value.

In another optional embodiment for controlling one or more progressive awards in at least one gaming machine, two or more wager levels are defined and a hierarchy is established among the wager levels. At least one progressive jackpot pool is established and the progressive jackpot pool is associated to at least one game outcome. The progressive jackpot pool is subdivided into two or more virtual progressive pools, each of which is associated with a wager level. Progressive awards associated with a wager level are defined as the sum of the virtual pool associated to the wager level and all other virtual pools associated to lesser wager levels in the hierarchy.

A wager is detected and, for each wager detected, a contribution is added into each virtual pool associated with the wager level of the wager detected and all lesser wager levels in the hierarchy. In response to the progressive payout trigger, the progressive award associated with the wager level of the wager resulting in the progressive payout trigger is issued.

In another optional embodiment of the present method directed to controlling and displaying at least two progressive awards for a gaming machine for a game in which wagers of varying wager levels may be placed, two or more wager levels are defined and a hierarchy among the wager levels is established. At least two virtual progressive pools are established and each virtual progressive pool is associated with a wager level. At least two progressive awards are established. Each progressive award is associated with a wager level and is defined as the sum of each virtual pool associated with the wager level and at least one lesser wager level, if any, in the hierarchy.

In this optional embodiment, the wager level for each wager placed before initiating the game is detected. In response to each wager detected, a progressive award is displayed. Such an embodiment enables a player to see, before a game is initiated, a visual display of the size of the progressive award available based on the size of the wager placed.

Once a player places a wager for play of the game, the wager level of the wagered amount is detected. A portion of the wagered amount is allocated to each virtual progressive pool associated with the wager level of a wagered amount detected and at least one lesser wager level, if any. In response to the progressive payout trigger, issuing the progressive award associated with the wager level of the wager resulting in the progressive payout trigger.

In yet another optional embodiment for a method for controlling one or more progressive jackpot pools for a game allowing two or more possible wager combinations of wager units and denominations, each wager combination is ranked with respect to the others. The ranking is optionally a function of one or more of the units wagered and denominations wagered.

At least two virtual progressive pools are defined and each virtual progressive pool is associated with a wager combination rank. A plurality of rate multipliers is also defined, and each rate multiplier is associated with a virtual pool.

A wager is detected and a contribution is added to each virtual pool associated with a wager combination of equal or lesser rank to the wager in direct proportion to the rate multiplier associated with the virtual pool. A plurality of progressive jackpot awards is established. Each progressive jackpot award is associated to a wager combination and each progressive jackpot award is defined as the sum of all virtual pools associated with wager combinations of equal or lesser rank to the wager. A progressive jackpot award associated to the wager combination resulting in a game outcome causing a progressive payout trigger is awarded.

In another optional embodiment, the present invention is a method for controlling one or more progressive awards for a game allowing two or more possible primary wager amounts and an optional side wager. The method includes defining two or more virtual pools and associating each virtual pool to a possible primary wager amount. Optionally, each virtual pool is associated to a range of possible primary wager amounts. A primary wager to prompt game play and a side wager are detected.

At least a portion of the side wager is allocated to the virtual pool associated with the primary wager mount and at least a portion of the side wager is allocated to at least one virtual pool associated with a primary wager amount of lesser value, if any. In response to the progressive payout trigger, a progressive award is issued. The progressive award of such an optional embodiment is equal to the sum of all virtual pools associated with the primary wager amount resulting in the progressive payout trigger and each primary wager amount of lesser value, if any.

In another optional embodiment of the present invention, the method is directed for controlling one or more progressive jackpot pools for a game in which primary wagers of various sizes or denominations may be placed and in which one or more optional side wagers may be placed. Two or more primary wager levels and one or more side wager options are defined. Each side wager option is associated to a progressive jackpot pool. Each progressive jackpot pool is subdivided into two or more virtual progressive pools and primary wager levels are associated to specific virtual progressive pools.

The size of the primary wager to prompt play along is detected. Similarly, any side wager is detected. For each side wager detected, a portion is allocated to all virtual pools associated with the primary wager level associated with the primary wager and all lesser primary wager levels, if any. In response to the progressive payout trigger, a progressive award is issued. In such an optional embodiment, the progressive award is equal to the sum of the virtual pools associated with the primary wager level associated with the primary wager resulting in the progressive payout trigger and all virtual pools associated to lesser primary wager levels.

### BRIEF DESCRIPTION OF THE DRAWINGS

FIG. 1 is a block diagram of a basic progressive system of the prior art;

FIG. 1B is a block diagram of an alternate embodiment of a basic progressive system of the prior art;

FIG. 1C is a block diagram of an alternate embodiment of a basic progressive system of the prior art;

FIG. 1D is a block diagram of a progressive controller of the prior art;

FIG. 2 is a block diagram of a multi-coin progressive controller according to an optional embodiment of the present invention;

FIG. 3 is a front view of a multi-coin progressive display according to an optional embodiment of the present invention;

FIG. 4 is a block diagram of a multi-coin progressive controller according to an optional embodiment of the present invention;

FIG. 5 is a block diagram of a multi-coin progressive controller according to an optional embodiment of the present invention;

FIG. 6 is a block diagram of a multi-denomination progressive system according to an optional embodiment of the present invention;

FIG. 7 is block diagram of a multi-denomination progressive controller according to an optional embodiment of the present invention;

FIG. 7B is a block diagram of a multi-denomination progressive controller according to an alternate optional embodiment of the present invention;

FIG. 8 is a front view of a multi-denomination progressive display according to an optional embodiment of the present invention;

FIG. 9 is a block diagram of a multi-denomination progressive controller and display according to an optional embodiment of the present invention;

FIG. 9B is a block diagram of a multi-denomination progressive controller and display according to an alternate optional embodiment of the present invention;

FIG. 10 is a block diagram of a multi-denomination progressive controller according to an optional embodiment of the present invention;

FIG. 11 is a block diagram of a mixed system progressive controller according to an optional embodiment of the present invention;

FIG. 12 is a block diagram of a mixed system progressive controller according to an optional embodiment of the present invention;

FIG. 13 is a rate multiplier matrix, total wager matrix, virtual pool matrix, and progressive jackpot matrix according to an optional embodiment of the present invention;

FIG. 13B is a rate multiplier matrix, total wager matrix, virtual pool matrix, and progressive jackpot matrix according to an optional embodiment of the present invention;

FIG. 13C is a rate multiplier matrix, total wager matrix, virtual pool matrix, and progressive jackpot matrix according to an optional embodiment of the present invention;

FIG. 13D is a rate multiplier matrix, total wager matrix, virtual pool matrix, and progressive jackpot matrix according to an optional embodiment of the present invention;

FIG. 13E is a rate multiplier matrix, total wager matrix, virtual pool matrix, and progressive jackpot matrix according to an optional embodiment of the present invention;

FIG. 14 is a front view of a gaming machine display according to an optional embodiment of the present invention;

FIG. 15 is a front view of a gaming machine according to an optional embodiment of the present invention;

FIG. 16 is a front view of a user set-up screen according to an optional embodiment of the present invention;

FIG. 16B is a front view of a user set-up screen according to an optional embodiment of the present invention;

FIG. 17 is flowchart of a progressive award method according to an optional embodiment of the present invention;

FIG. 18 is a flowchart of a progressive award method according to an optional embodiment of the present invention;

FIG. 19 is a flowchart of a single axis, completely overlapped progressive award method according to an optional embodiment of the present invention;

FIG. 19B is a flowchart of a completely overlapped, multi-denomination progressive award method according to an optional embodiment of the present invention;

FIG. 20 is a flowchart of a partially overlapped, dual-axis progressive award method according to an optional embodiment of the present invention;

FIG. 21 is a flowchart of a partially overlapped, multi-axis progressive award method according to an optional embodiment of the present invention;

FIG. 22 is an elevated perspective view of a gaming table according to an optional embodiment of the present invention.

### DETAILED DESCRIPTION

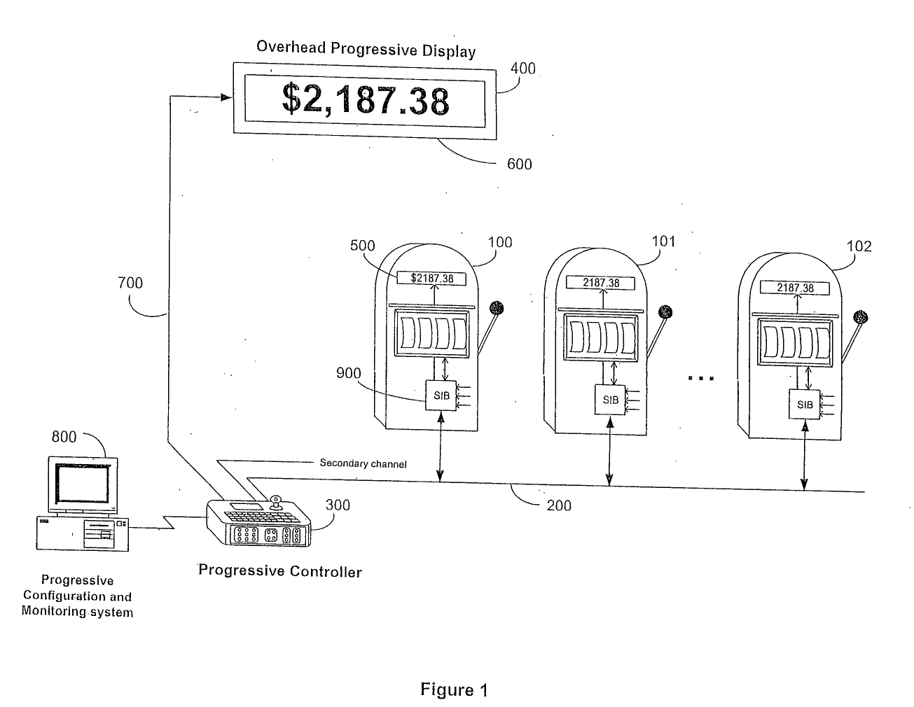

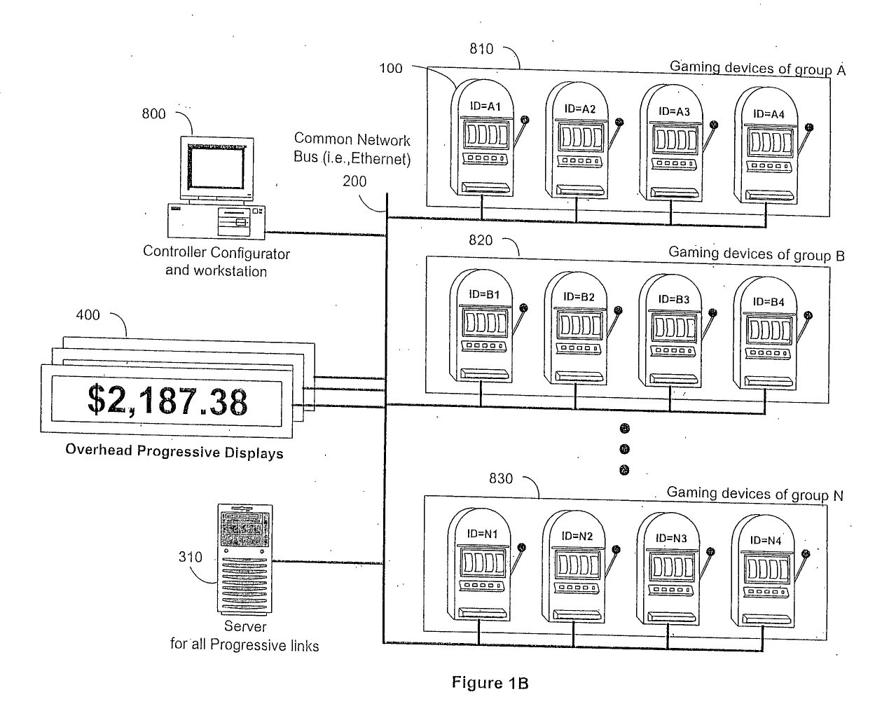

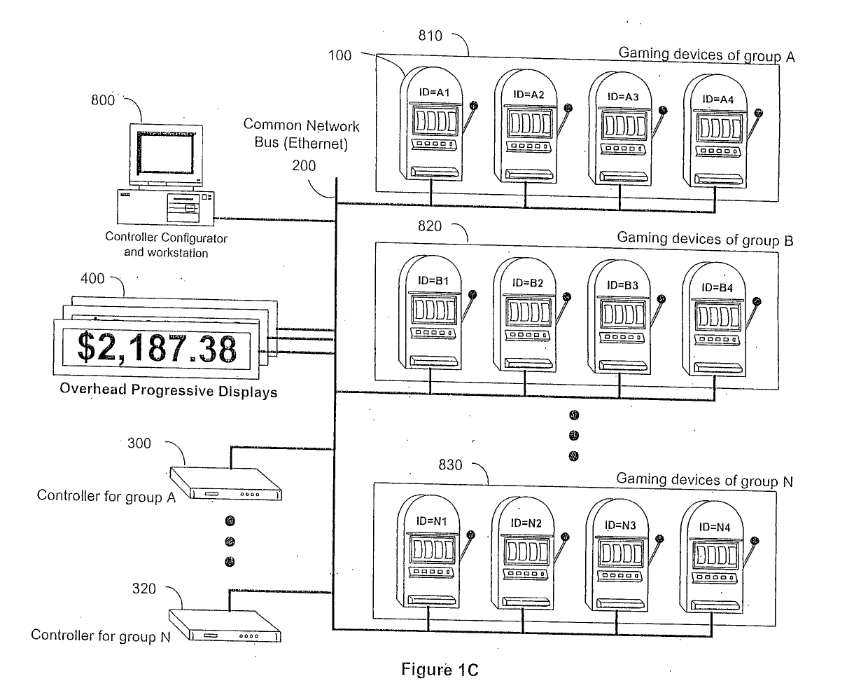

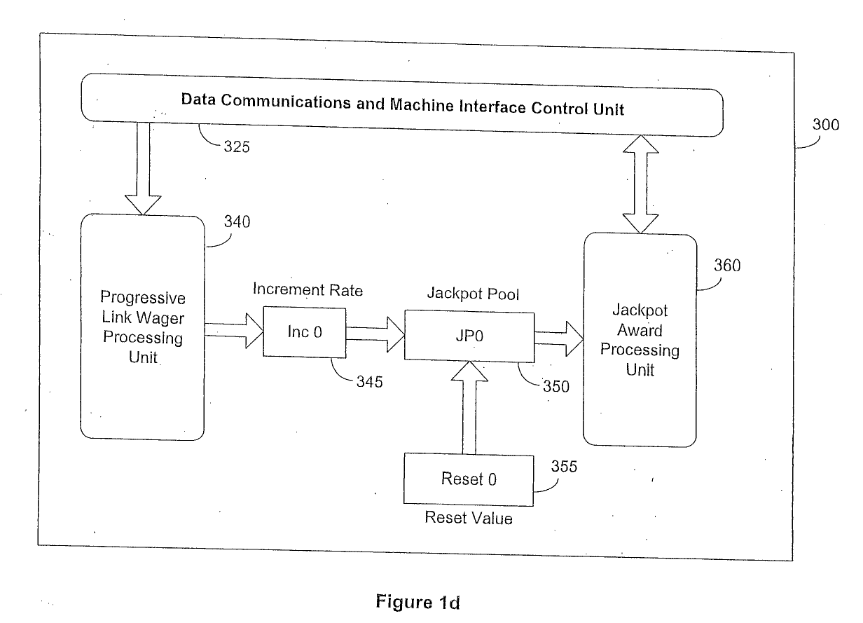

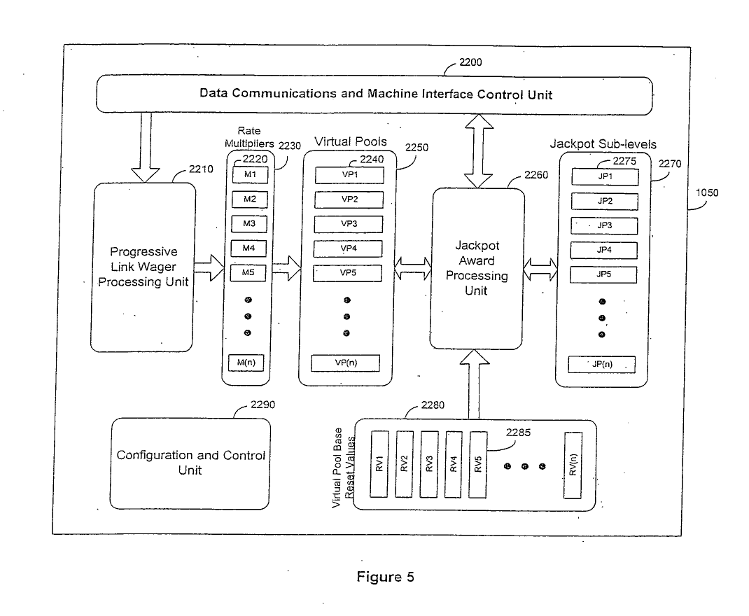

A system according to an optional embodiment of the present invention is generally depicted in FIGS. 5 & 6. FIG. 5 is a block diagram used to illustrate important methods of the progressive controller of the present invention. Like FIG. 1D, it is a simplified block diagram showing important elements of the disclosed invention. FIG. 5 is used to show important elements, however, it does not attempt to describe the entire complexity of a progressive controller, for purpose of illustration.

In FIG. 5, controller 1050 consists of several generalized logic functions, such as the Progressive Link Wager Processing unit 2210, and the Jackpot Award Processing Unit 2260, generally implemented in software or firmware, and not necessarily independent as drawn in FIG. 5. The Wager processing unit 2210 applies each wager to an array of rate multipliers 2230 using additional methods described later for each option of the invention. The resulting output of the wager and rate multipliers function yields a progressive contribution that is added to a series of virtual pools 2250, in a manner to be described later. A Jackpot Award processing unit 2260 creates a series of graduated jackpot prizes 2270 by summing sequences of virtual pools in the virtual pool array 2250 in a manner described later. The jackpot award processing unit 2260 receives jackpot win information from EGMs of the progressive link. Upon receiving a jackpot hit data packet, the jackpot award process 2260 awards the player with a jackpot value from a series of jackpot values 2270. The jackpot award processing unit 2260 resets the progressive jackpot by resetting the values of the contributing virtual pools in the virtual pool array 2250 by copying corresponding values from the Virtual Pool Base Reset Value array 2280 in manner described later. Jackpot values are re-calculated in real time, and upon any state change in their values.

It is important to note that fundamental elements are associated to each progressive jackpot group within the system of the present invention. In FIG. 5, these fundamental elements are the array of rate multipliers 2230, the array of virtual pools 2250, the array of jackpot prizes, or jackpot awards 2270, and the array of virtual pool reset values 2280. These fundamental elements must be repeated for each progressive group, and each separate progressive link as so defined. Software processing units 2210, 2270 & 2290 may or may not be repeated depending on option for embodiment. For example, a multi-tasking software system of FIG. 1B might use a single set of software instructions to control a plurality of progressive links; however, each progressive link, and in fact each progressive group, would likely have its own set of data elements.

For purposes of illustration, the examples shown herein are for a single link, single group progressive link to help clarify the important aspects of the disclosed invention.

It should be expressly understood that the present invention is easily extended to provide for multiple progressive levels, and such extension is straightforward for those practiced in the art. However, for illustration purposes and to help simplify concepts, a single progressive jackpot level is assumed and used in examples throughout this invention.

The term “progressive level” may cause some confusion when describing methods of the present invention. The reason is that the methods of the present invention divide a standard jackpot pool into multiple jackpot pools. Therefore, it is possible to refer to each sub-division of the progressive pool as a “level”. Therefore, use of the term “progressive level” may indicate either a level as it is historically defined in prior art, or it may be used to describe one of a series of sub-jackpots of the present invention, which are all associated with a single progressive jackpot pool, as described in this document. One way to avoid this problem is to use the term “group” when referring to progressive jackpot levels, also common in prior art, and use the term “sub-levels” to describe each level of a single progressive jackpot as it pertains to the methods of the present invention.

It should be noted that the term “level” is used herein to refer to the sub-levels created by the present invention. This term should not be confused with the term level as it historically denotes a different jackpot group.

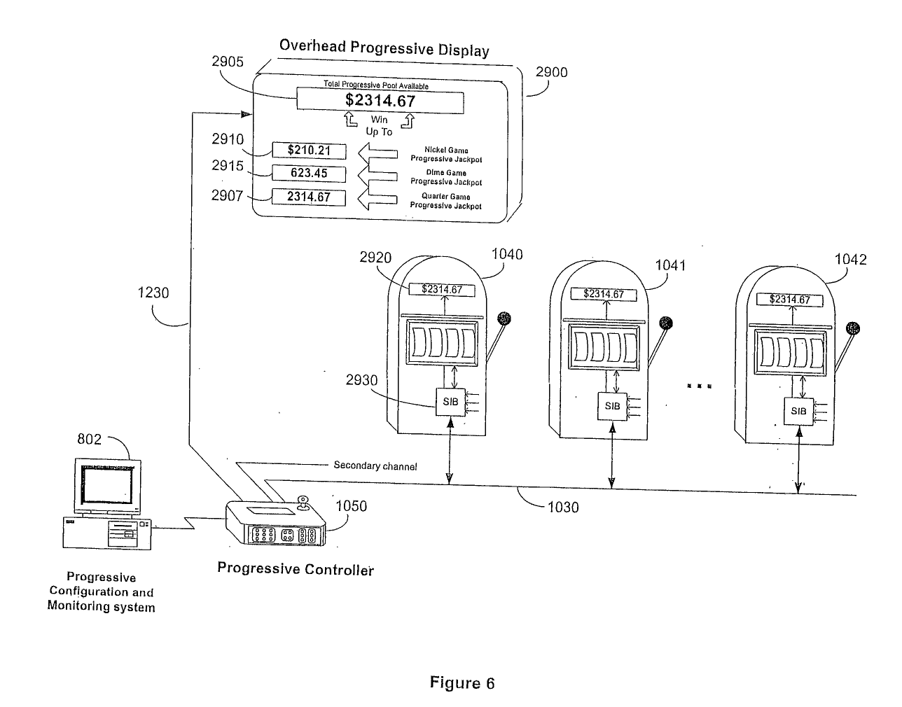

In FIG. 6, a typical single controller configuration is shown using some methods of the disclosed invention. In the figure, progressive controller 1050 is shown inter-connected in much the same way as the prior art controller 300 of FIG. 1. Some basic elements regarding the overhead display 2900 of FIG. 6 suggest several basic differences from a standard progressive system of FIG. 1. For example, the progressive prize award is split into different sized awards, each award associated with a different wager. Much of the differences of FIG. 6 arise from the new manner in which progressive awards are tracked and managed, and how they are offered back to the player.

FIG. 6 shows only one embodiment, configuration, and basic option of the methods of the disclosed invention. However, FIG. 6 illustrates a basic example of how the system embodiments overlap with the prior art, yet also how the methods differ. It should be noted that many different types of system configurations can be used for the disclosed invention, such as those of FIGS. 1B and 1C. It should be noted that these diagrams are basic and simplified, and are not meant to be a limitation of the methods disclosed herein.

Tracking Progressive Contributions

In any of the embodiments disclosed, that is, for multi-denomination embodiments, multi-coin embodiments, table game embodiments, and combinations thereof, the progressive pools may be funded in many different ways. For example, in one optional embodiment, the progressive contribution is influenced by the size of the wager made on the primary game. In such an optional embodiment, the size of the progressive wager, and consequently the size of the progressive jackpot award for which the player is eligible, is determined by the size of the primary wager.

In one such optional embodiment, the progressive pools are funded by a separate side wager that is proportional to, or a percentage of, the primary game wager. This embodiment is described in greater detail below in the discussion regarding the application to table games. However, it is expressly contemplated that the side wager contribution method could be used in gaming machines as well as table games. In another option, the progressive pools are funded by a percentage take of the primary game wager itself. The main difference between these two options is that in the first option, the player can elect to place the side bet to “buy” eligibility into the progressive game. Moreover, the player can select the progressive sub-level for which the player plays by changing the size of the side wager or primary wager. In a variation of this option, it is expressly contemplated that a plurality of progressive links, or distinct progressive pools, can be offered to the player. Because the player may place an additional side wager contribution to each, any or all of the progressive pools offered, the player becomes eligible to win each, any or all of the progressive pools respectively. In yet another variation, the progressive system of the present invention need not tie the side wager value to the primary wager, therefore, the side wager may be independent to the primary game wager. In yet another variation, the progressive system of the present invention need not tie the winning progressive game outcome to the primary game outcome.

In the second option, the player can be eligible for the progressive game as a result of playing the primary game itself, i.e. the player is always eligible for the progressive jackpot for each wager placed on the primary game.

Multi-Coin Progressive Function:

The multi-coin progressive function of the present invention is described first. This function is distinct from the multi-denomination function that will be described later. The present invention is directed to each function separately, as well as both functions in combination. The present invention may also incorporate prior art methods and prior art embodiments, as well as combine the present invention with prior art methods.

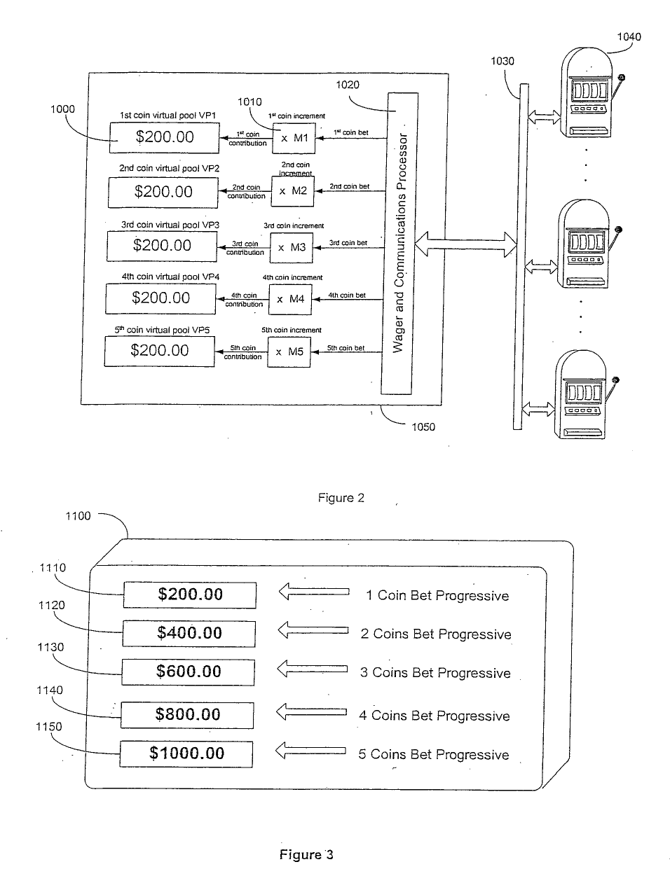

The block diagram of FIG. 2 illustrates a simplified block diagram for processing wagers of 5-coin multiplier games, by means of example. FIG. 2 shows a plurality of gaming machines 1040 communicating with a progressive controller unit 1050. Optionally, the communication is carried via a communications network 1030. A communications processing function 1020 within the progressive controller 1050 routes coin wager information to a plurality of progressive increment multipliers 1010. This function is optionally firmware or software within a progressive controller 1050. The progressive controller 1050 of the present invention tracks and accumulates progressive contributions from each coin of each wager in a separate intermediate pool or “virtual pool” 1000.

For example, in a traditional five coin, bet multiplier progressive game, it is typical that a player wagers five coins to be eligible for the progressive jackpot. Therefore, in the present invention, each coin level of that wager would affect a separate virtual pool 1000 within the controller 1050. In addition, each contribution to each virtual pool is calculated using a separate progressive increment factor 1010. Therefore, for each coin level of each wager placed, it is possible to have the same or a different increment factor, where each progressive increment factor for each coin of each wager is labeled M1 through M5 in the example. In FIG. 2, each block 1010, labeled M1 through M5, represents a separate percentage multiplier, or equivalently, a fixed increment amount, to be added to the respective virtual pool 1000.

It is expressly contemplated that the present invention is not limited to 5-coin games or only 5 virtual pools 1000 as shown in FIG. 2. Rather, any number of coins per wager can be supported by the present invention by providing a virtual pool 1000 for each coin level that can be bet.

Calculating Progressive Awards:

In FIGS. 2, 3 & 4, the reason for tracking each coin bet of each wager placed is made clear. In these figures, the functions for calculating the progressive jackpot is described in block form for simplicity.

FIG. 3 shows how an overhead display might look for the case of a single group progressive jackpot of the present invention applied to a 5-coin multiplier game. By means of example, FIG. 3 shows a progressive jackpot display 1100 showing five distinct progressive prize levels corresponding to when a player is awarded the progressive jackpot when a single coin is wagered 1110, two coins are wagered 1120, three are coins wagered 1130, four coins are wagered 1140, and when five coins are wagered 1150.

Unlike prior art progressive systems, the multi-coin function of the present invention provides a progressive award to all players of the progressive link, regardless of wager amount. In other words, it is possible for a player to wager only a single coin, and still be eligible for a progressive prize. In FIG. 3, and for purposes of illustration, the values of the progressive prize levels are shown having $200, $400, $600, $800 and $1000 dollars, corresponding to one coin bet, two coins bet, three coins bet, four coins bet, and five coins bet respectively. It is important to note that in this embodiment, a player wagering only a single coin is not entitled to the same prize value as those players wagering more than one coin.

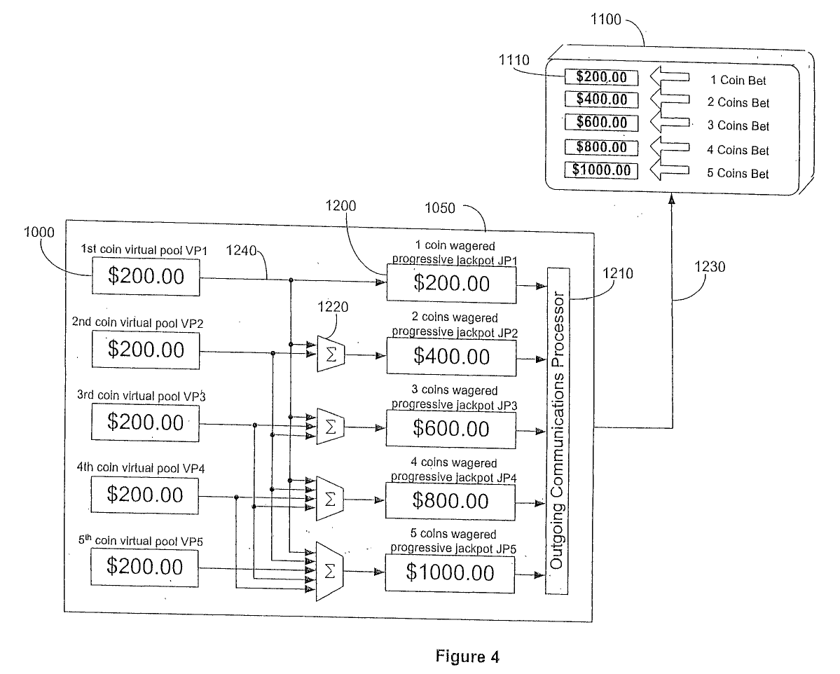

It should be understood that the multiple jackpot values in FIG. 3 are not multiple jackpot groups, or “levels”, as encountered in the prior art. Instead, the multiple jackpot values 1110-1150 are still part of the same progressive jackpot pool and the same progressive jackpot group, or level. The multiple jackpot values in FIG. 3 are associated to only one particular game paytable outcome. The manner in which this is accomplished is explained next using FIG. 4.

FIG. 4 is a simplified block diagram of the progressive controller 1050 of the present invention. Only pertinent details for the following explanation are shown. In FIG. 4, the progressive controller 1050 is connected via network 1230 to progressive overhead display 1100. Network 1230 may be dedicated to communicating to overhead displays, or the network 1030 of FIG. 2 may be employed to do the same, or both, depending on the hardware embodiment.

In the simplified block diagram of FIG. 4, the portion of the progressive controller 1050 controlling the virtual pools is shown. By means of example, progressive controller 1050 supports five virtual progressive pools, such as virtual pool 1000 herein referred to as VP1. As explained before, each virtual pool tracks progressive contributions for each coin level of each wager. Also shown in FIG. 4 are five progressive jackpot values, such as jackpot value 1200 herein referred to as JP1. One jackpot value is calculated by the controller 1050 for each possible coin level of wagering; in the example embodiment of FIG. 4, five coin levels are shown. Each jackpot value, JP1 through JP5, are the actual awards offered to players; therefore, we will refer to these jackpot values as “displayed progressive jackpots” to denote their significance, and to distinguish them from other internal pools, such as virtual pools, that are managed internally by the progressive controller 1050, but are not necessarily viewed by players. (although the present invention is not to be limited by this). Note that “levels of wagering” are not to be confused with “jackpot levels” as used in the art to describe multiple jackpots.

A player who consistently bets one coin per wager is only contributing to virtual pool VP1. As a result, if that player hits the game combination which results in a progressive jackpot award, then that player is only entitled to contributions made by the first coin bet of all wagers placed since the last progressive jackpot was awarded. In that case, the player is awarded the value tracked by virtual pool VP1. As illustrated in FIG. 4, progressive jackpot JP1 only relates to, and is influenced by, the value tracked by VP1, as shown by the straight arrow 1240 leading from VP1 to JP1.

A player who consistently bets two coins per wager is contributing to both virtual pool VP1 as well as virtual pool VP2. As a result, if that player wins the progressive jackpot, then that player is awarded an amount JP2 that tracks contributions made by the first and second coin bet of all wagers placed; thus, JP2 relates to, and is influenced by, the sum of virtual pool VP1 and VP2. As shown in FIG. 4, the value for the 2 coin progressive jackpot is the sum of virtual pool VP1 and VP2. In general, the following rule is noted: A wager of “M” number of coins affects contributions to virtual pools VP(1) through VP(M). If a player who wagers M coins hits the progressive jackpot, the player is awarded the progressive amount whose value is the sum of virtual pools VP(1) through VP(M).

The value for each jackpot is therefore derived from a summation of virtual pools given by:

$$JP ( n ) = {\sum }_{p = 1}^{n} VP ( p )$$

where the index (n) is the number of coins wagered for each jackpot value, (n) starts at one, and is limited to the number of coins in the max coin wager, N.

In practice, the progressive controller 1050 is continually calculating the current value of all jackpots JP1 through JPn, where n is the number of coins per wager. The controller is displaying jackpots JP1 through JPn to the player in real-time. The progressive controller 1050 is also continually updating the value of virtual pools VP1 through VPn as players initiate wagers in all gaming devices connected to the progressive link. An optional manner in which the controller 1050 calculates contributions to each virtual pool VPn is described in greater detail below. Without regard to the particular implementation, however, the progressive controller 1050 tracks contributions of each wager by considering each coin of each wager separately. Also, the progressive controller 1050 calculates progressive jackpots in a manner that reflects the fair contributions made by each wager placed.

Resetting the Progressive Jackpot

The controller must “reset” the progressive jackpot after the jackpot has been awarded. In prior art progressive systems, a reset value is programmed into the progressive controller. This reset value is restored into the progressive jackpot once the progressive jackpot is hit. This value is seldom zero, but instead typically represents the “base pay” amount the gaming device would normally pay non-progressive wins of the same winning combination and the same wager amount. For example, in prior art systems, if the standard base pay of the gaming device when maximum coins are wagered is $1000, then the reset value will typically be $1000. The prior art system only awards jackpots on maximum coins played, so the reset value of the progressive jackpot is typically the standard base pay of the game with maximum coins bet.

The present invention may optionally use a different procedure to reset the jackpot amount. In the case of a single coin wager triggering the progressive jackpot, only virtual pool VP1 is reset to its base value. This base value may be any value programmed into the progressive controller, but in practice, it is typically representative of the base pay of the game when only one coin is wagered.

In the example given of a 5-coin multiplier game, the base pay of the underlying game without the progressive feature, with one coin wagered, is 200 coins. Therefore, 200 coins are restored back into the virtual pool VP1. To continue this further, the base pay of the underlying game when two coins are wagered is double that of one coin, or 400 coins. However, because the progressive controller 1050 of the present invention tracks coin bets of each wager separately, the reset value of VP2 is also 200 coins. Because the calculated jackpot for a multiple coin bet is related to, and influenced by the sums of each preceding virtual pool, the reset value for each virtual pool is the normal base pay of the underlying game when one coin is wagered. As an example, for a two coin bet, the calculated jackpot is the sum of virtual pool VP1 and VP2 as shown in FIG. 4, and the reset value for the two coin progressive jackpot is 400 coins, that is, 200 coins per level. It should be noted that in FIG. 4, the sample values used in the diagram are suggestive of the initial start up state of the progressive jackpot, and therefore suffice in this explanation. In general, however, the values of the virtual pools could differ.

It should be noted that reset values for each virtual pool VP1 through VPN can be any value, not simply the normal single coin base pay of the underlying gaming device. As shown in FIG. 5, the controller supports separate reset values 2280 RV(n) for each virtual pool VP(n) of virtual pool array 2240. These reset values can be any value. By means of the example given, a typical scenario is outlined which allows the present invention to be compared closely to typical prior art progressive configurations, but this is not meant to be a limitation of the present invention, only an explanation of a typical implementation. In terms of this comparison, the prior art system of the example will only offer a progressive jackpot when 5 coins are bet, so the reset value is $1000. For the controller of the present invention, progressive awards are awarded regardless of the wager size. Therefore, for an equivalent comparison, one fifth of the prior art base pay is used as a reset value for each of the five reset values RST1 through RST5.

In the example above, the progressive reset value for players wagering 5 coins is 1000 coins for both the prior art and the present invention. The reason being, in the present invention, the reset value displayed for players wagering 5 coins is the sum of VP1 through VP5 as previously explained. Therefore, the displayed jackpot value for 5 coin wagers is 5 times 200 coins, or 1000 coins. It should be noted that the reset values could be different, such as graduated upwards, to create an enticement to play maximum coin wagers for progressive systems of the present invention.

When a progressive jackpot occurs with (m) coins bet, then virtual pools VP1 through VPm are reset to their corresponding base value. The result to the player is that any progressive jackpot value corresponding to coins 1 through (m) wagered will reset, while any potential progressive jackpot values greater than JPm will decrease by an amount equal to virtual pools VP1 through VPm minus the reset values that are restored in VP1 through VPm.

The reset action to virtual pools VP(n) immediately after a jackpot is detected and awarded is given by:
VP(n)=RV(n),
for all n=1 to m,

Where m=coins wagered, and RV(n) is the nth reset value cooresponding to the nth virtual pool VP(n).

Therefore, in an optional embodiment, the progressive jackpot pool can decrease in the method of the present invention without completely resetting. The reset process in such an optional embodiment clears progressive jackpots at the same coin wager level associated with the wager that hit the jackpot. In the same action, the reset process also resets all progressive levels of a lesser coin wager level in such an embodiment. However, jackpots that may exist at a larger coin wager level are not reset, however, in general, they will be seen to decrease by the amount awarded minus any possible reset vale restored to the jackpots.

Detailed Explanation of Increment Rates and Method

In one optional embodiment, the progressive controller of the present invention uses a separate increment rate multiplier for each coin bet of each wager. The resulting value produced by the output of each multiplier M1 through Mn is added to each virtual pool VP1 through VPn respectively, where (n) is the maximum number of coins per wager. For example, the first coin of each wager is multiplied by coin multiplier M1; the resulting contribution is then added to virtual pool VP1. Likewise, the second coin of each wager is multiplied by coin multiplier M2; the resulting contribution is then added to virtual pool VP2. In general, the Nth coin of each wager is multiplied by the Nth coin multiplier Mn and the resulting contribution is added to virtual pool VPn. It is noted that the coin multipliers M1 through Mn could differ, could be the same, or could include some different values and other values that are the same.

In this optional embodiment, the progressive system allows a graduated increment rate to be supported. A graduated increment rate allows larger wagers to contribute a larger percentage contribution to the total progressive jackpot pool. In the prior art, a fixed percentage contribution is made to the progressive pool regardless of wager size.

For example, it may be desirable to graduate the increment rate so that a higher percentage contribution to the progressive pool is made when a larger wager is placed. This can have the effect that progressive jackpots for max coin players are proportionately greater, given that wagers of all sizes are even over time. This is an important feature, since if each percentage contribution Mn to each associated virtual pool VPn is the same, the progressive jackpots associated with smaller wagers will grow at a disproportionately larger rate, assuming that all wager sizes occur equally over time. In such a case, the progressive values will favor the player placing a single coin wager since the expectation for the single coin wager would be greater than that of higher wagers.

To avoid that problem in one optional embodiment, a series of graduated increment rates 1010 M1 through Mn may be applied. As an optional requirement, the progressive jackpots for each wager size should grow in proportion to the wager size itself. Using the 5 coin multiplier example, and under the assumption that the same frequency of wager sizes is anticipated, the increment rates may be calculated to satisfy the following condition:
M1×5=M2×4=M3×3=M4×2=M5×1 (Eqn 1)
where M5 is the increment rate for the 5th coin of each wager as in FIG. 2.

That is, in such an optional embodiment, the increment rate for the fifth coin of a wager, M5, could be 5 times the increment rate for the first coin of a wager, M1. Because it is assumed in this example that the frequency of all wager levels is the same, i.e., the number of total wagers have an even number of 1, 2, 3, 4 and 5 coin wagers over time, the proportion of fixed coin contributions diverted in FIG. 2 to each virtual pool is known. Having that information, the progressive rate multipliers 1010 M1 through M5 can be adjusted to satisfy the condition of Eqn 1 so that all progressive jackpots for each associated wager level increase at a rate proportional to the size of the wager.

One optional method sets the largest rate multiplier to one, and makes all other rate multipliers a fraction less than one. The use of an overall scale factor is then used to scale the rate multipliers appropriately to satisfy actual increment rates in practice. By definition, the processes of setting the largest rate multiplier to one, then applying the relation of Eqn 1 is referred to as normalizing the rate multiplier scale. Doing so in the example yields:
M5=1.0
M4=0.5
M3=0.333
M2=0.250
M1=0.20

The results of Eqn 1 have a general form for a coin multiplier progressive jackpot of the present invention having up to (n) coins maximum wager. This general form is:
M1×n=M2×(n−1)=M3×(n−2)= . . . =Mn×1 (Eqn 2)

The conditions for a “proportionally” growing multi-coin progressive jackpot of the present invention are directly related to the relative values of each coin multiplier. For purposes of the present invention, the multi-coin jackpot system is “proportional” when the coin multipliers M1 through Mn satisfy the conditions of Eqn 2, where progressive jackpots for each wager size grow in proportion to the wager size itself, assuming an even number of wager sizes is placed over time.

In the case of the example, the maximum progressive jackpot contribution, R_{$max}, is the progressive increment for the maximum size wager, denoted as R_{$5} in the example:
R_{$5}=R_{$max}=(M1+M2+M3+M4+M5)*S (Eqn 3)
where Mn is the rate multiplier associated with the nth unit bet of each wager, and S is an appropriate scaling factor used to yield actual dollar values. In practice, the scaling factor exists as a separate scaling process applied to all rate multipliers, or otherwise, S is combined into each rate multiplier.

The maximum possible progressive contribution may be represented as a percentage contribution, or progressive increment rate, Rmax, using the following relation:
Rmax=R_{$max}/(max wager) (Eqn 3b)
The increment for all other wager sizes in the example, denoted as R_{$1} through R_{$4} are:
R_{$1}=M1*S (Eqn 4)
R_{$2}=(M1+M2)*S (Eqn 5)
R_{$3}=(M1+M2+M3)*S (Eqn 6)
R_{$4}=(M1+M2+M3+M4)*S (Eqn 7)
where R_{$n} represents the monetary contribution each specific wager level will make to the progressive pool. These values may also be converted to a corresponding increment percentage rate by dividing the contribution by its wager value, given by:
Rₙ=R_{$n}/Wₙ (Eqn 7b)
where Wₙ is the value of the nth level wager.

It should be noted that the number of wager levels can be extended in an unlimited fashion; the example above shows five such wager levels, but the method of the present invention is not limited to five levels in practice. Therefore, in an optional embodiment, the maximum overall progressive increment equals the increment for the maximum coin bet (n), and in general is:
R_{$n}=(M1+M2+M3+ . . . +Mn)*S (Eqn 8)
where S is a suitable scaling factor as discussed above.

In one method for establishing actual values for rate multipliers M1 through Mn and scale factor S, the overall maximum percentage increment rate is chosen. In practice, and in prior art systems, the percentage increment rate is decided by the casino; furthermore, the increment rate is essentially additional money that is diverted back to the player. Therefore, the final choice of the increment percentage is based upon several factors. The most important factors are how much additional payback can be afforded for a given underlying game paytable, and whether such an additional payback will ultimately generate additional income in terms of additional play, and/or play made with larger wagers.

Regardless of the chosen amount of increment percentage, this percentage is typically set by the coin multipliers M1 through Mn and scale factor S. In the prior art, the choice of the overall increment percentage was simple, as it affected each wager in the same way regardless of wager size. In the prior art, if a 1% increment rate is decided upon, a 1% contribution is made to the progressive pool from each wager regardless of the size of each wager. In the present invention, however, the maximum increment rate, Rmax, and the average increment rate, Rave, are not necessarily the same. In fact, increment rates may differ between levels of wagering.

As defined, Rmax is directly influenced by the values contained in rate multipliers M1 through Mn. Rmax is the maximum possible increment rate, and this value does not change based upon game play history. This parameter is therefore a conservative parameter to use to adjust rate multipliers M1 through Mn to achieve the desired overall increment rate. It should be noted that increment rates per wager level can vary, in which case the increment rate for each wager level can be calculated.

Rave is a statistical measure and is influenced by the values used for rate multipliers M1 through Mn as well as the history of game play within the progressive link. Rave is defined herein as the actual total increment rate of all underlying games. Therefore, in the method of the present invention, additional measures of progressive increment can be formulated. Rate multipliers R1 through Rn may be adjusted to modify and influence these additional statistical measures of progressive contribution in one option.

Therefore, an optional method for incorporating the chosen increment rate into the coin multipliers M1 through Mn is to ensure that the maximum increment rate, Rmax, is equal to the chosen increment rate. To do so, the increment rate of the maximum size wager, as given in Eqn 8, is set equal to the chosen increment rate. By combining the relationship of Eqn 2 with that of Rmax in Eqn 8, actual scaled multiplier values M1 through Mn for use within the controller can be determined.

In an alternative but equivalent optional embodiment, an overall scale factor can be determined for all coin multipliers, wherein the maximum coin multiplier Mn is set to 1 and all other coin multipliers satisfy the relation of Eqn 2. In this optional representation, a scale factor is needed to adjust the multiplier to allow contributions to the progressive jackpot to meet the chosen percentage. This method may be easier to analyze and adjust, although it is substantially equivalent to using a pre-scaled multiplier.

It is expressly noted that the method of the present invention is not limited to having the scale factor already factored into each coin multiplier; an equivalent embodiment and method may use a separate scale factor multiplied into each “normalized” scale factor. Furthermore, it is expressly noted that the chosen increment rate of the multi-coin jackpot need not be equivalent to the maximum coin increment percentage Rmax. For example, the chosen increment percentage may be set equal to the average increment percentage. In such an optional embodiment, the average increment percentage is a function of the play history of the game, i.e. a function of the actual distribution of wager sizes played.

In another alternative embodiment of the present invention, the chosen increment rate for the progressive jackpot may be compared to the average progressive increment of the system, wherein the system dynamically alters the coin multipliers M1 through Mn in response to game play, and in accordance to maintaining a running equivalence between the chosen increment percentage, and the actual average increment percentage based upon game play history.

The term increment rate should also be better clarified. It is to be understood by those skilled in the art that the terms progressive increment, and progressive increment rate may refer to the same thing, only using different units. For example, a progressive increment may be described as a percentage, and therefore defines a progressive increment rate. A rate is simply a unit-less factor that will be applied to a monetary value in this case, which yields an actual progressive increment, in terms of a fixed amount of money.

Rate multipliers can be thought of as a percentage rate, i.e., a multiplier, or a fixed increment amount, i.e., the amount to be added to its respective virtual pool when a wager of the appropriate level is processed. In most cases in this document, when a rate multiplier is expressed as a percentage, it is denoted as Mₙ, otherwise, if expressed as a resultant value, it is denoted as M_{$n}. In the examples above, a scaling factor S above is used to convert each rate multiplier into an actual monetary value to be added to each virtual pool. When the rate multipliers are normalized, then the scale factor S converts each ratio to an actual increment amount.

The reason that the method of the present invention is fair to each player is best understood by considering that each coin wagered is in effect a “buy-in” of each virtual pool. For example, a single coin player receives a “buy-in” for virtual pool VP1 only. On the other hand, a two-coin player receives a buy-in for both VP1 and VP2 pools. In a likewise manner, an N coin player receives a buy-in for virtual pools VP1 through VPN. Since the chances remain the same for all players that each game results in a winning game combination for the progressive jackpot, each player has the same chance of receiving their respective sums of each virtual pool they have bought into.

Additional Adjustments to Promote Larger Wagers

In practice, it may be desirable to further graduate the rate of growth of each progressive jackpot offered to each wager size. This can be accomplished by further graduating the relative percentage contribution of each coin multiplier 1010 M1 through M5 as shown in FIG. 2. For example, by adding another weight factor Wn to the equation 2, the following conditions are set forth to allow a proportionally larger jackpot growth rate for players placing larger, but incremental sized wagers:
M1×5×W1=M2×4×W2=M3×3×W3=M4×2×W2=M5 (Eqn 10)

In equation 10, and by means of example, the following weights could be established:
W1=5
W2=4
W3=3
W4=2

The additional weights as suggested above would dramatically skew the proportionality of progressive jackpot growth towards the maximum coin wager. However, it should be noted that less aggressive weighting may also be used, such as:
W1=3.0
W2=2.5
W3=2.0
W4=1.5

In such an optional embodiment, additional weighting in the direction of greater increments for each additional coin of each wager will increase the rate of jackpot growth of larger wagers as compared to jackpot growth of smaller wagers with respect to wager size. These additional weight factors as introduced in Eqn 9 will essentially affect the proportionality of jackpots with respect to the wager size itself. In other words, the graduated weighting factors above will modify the proportional system so that it is a non-proportional system with respect to wager size as defined. However, in doing so, the method of the present invention continues to treat all players fairly regardless of wager size.

It should be noted that alternate optional methods for tracking each coin bet for each wager placed is possible. For example, in the Figures, an alternate means for implementing the invention is disclosed in lieu of explicit support of virtual pools as shown in FIG. 2. In this optional embodiment, and by means of example, 5 coin wager meters are used. These meters simply track each occurrence of each possible wager size. For example, meter 1 tracks occurrences of a single coin wager; meter 2 tracks occurrences of a two coin wager, and so on. The values of these meters, in combination with an increment rate and base value for each meter, can be used to calculate the equivalent value of the displayed jackpots as shown in FIG. 3.

It should be noted that a global reset value and a global increment rate could be used in lieu of separate increment rates and separate reset values. Any combination of separate or global increment rates and reset values could be used to implement the disclosed invention.

It should be noted that the method of the present invention can be used in tandem with prior art methods to create a dual method progressive system. For example, contributions from all coins wagered could be used to fund yet another virtual pool. This virtual pool would represent that portion of the overall jackpot that is only eligible to max coin players, as in typical prior art methods. This process could occur in tandem with the processes set forth above, such as that shown in FIGS. 2-4. In this optional combination method, some amount of the contribution of every wager funds a progressive pool that is eligible to only max coin players, as in the prior art. Other contributions to virtual pools VP1 through VPN would fund jackpots that are eligible to their respective wager size, as set forth above.

Multi-Denominational Progressive Method

The progressive function for multi-denominational wagering provides a consistent, fair, and flexible method for establishing a single progressive jackpot pool across similar games of different wager denomination. For example, the method of the present invention can link gaming devices that support 5 cent, 25 cent and 1 dollar denominations to the same progressive pool. These gaming devices may be fixed denomination (but differ in denomination from one another), or they may support a dynamic selection of denomination, as is commonly the case when a cashless gaming system is employed. (i.e., the denomination is selected at the gaming device by the player). To be fair, it is assumed that each underlying game supports the same winning combinations and payout odds, however, this is not a limitation of the present invention.

The method of linking games of different denominations is not readily apparent. It appears that there is no fair method of linking players who wager, say 5 cents, to a progressive pool shared by players who wager, say $1. However, the optional method outlined in the present invention for multi-coin games can be extended to the multi-denomination case.

In the following discussions, we will use the following circumstances and examples to illustrate the method of the present invention for linking games of different denomination to a single progressive pool.

Consider the example where there are a number of gaming machines linked to a common progressive pool. These games are fixed in denomination, however, three different denominations exist; there are 5 cent games, 10 cent games, and 25 cent denomination games.

Relative to each other, the games can be treated as coin multiples of a single denomination. For example, the 10 cent game wager is two times the 5 cent game, so it is treated like the same 5 cent game, only supporting a two times multiplied wager and payout table. The 25 cent game wager is 5 times the 5 cent game, so it is treated like the same 5 cent game, only supporting a 5 times multiplied wager and payout table. Note that the underlying games are assumed to be the same, the only thing different is the wager amount.

Therefore, the concepts of the present invention developed for coin multipliers can be applied to link games of different wager denomination together to one progressive jackpot pool. To do this, we assume a “virtual” wager denomination throughout, herein referred to as the unit bet wager. The most efficient choice for the unit bet wager is the greatest common divisor (GCD) of all linked denominations. In the example, that would be 5 cents, as this is the greatest value that evenly divides all denominations in the example, i.e. 5 cents evenly divides 5, 10 and 25 cent wagers.

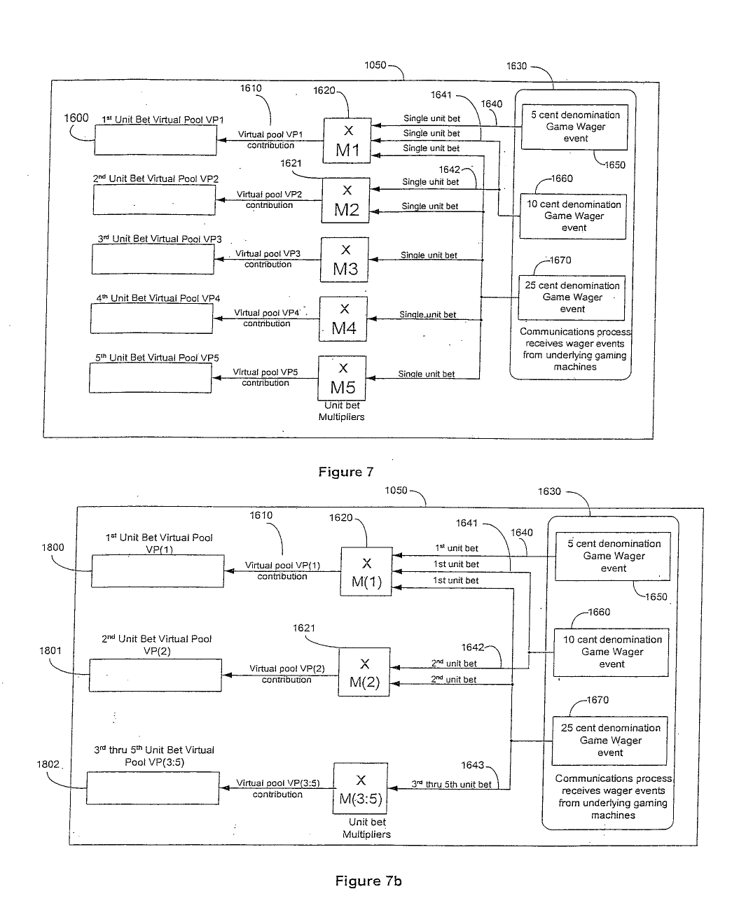

FIG. 7 shows, by means of example, five virtual pools 1600, each virtual pool VPn representing the tally of contributions from its respective single unit bet 1640. (The incremental unit bet wager can be analogized to a coin from the previous example for multi-coin progressives). If a player initiates play on a 5 cent game, the progressive controller communications process 1630 signals detection of a 5 cent game wager play event 1650. Thus, contributions from that wager are generated by the respective single unit bet 1640 multiplied by unit bet multiplier 1620. The result is a unit bet contribution 1610 added into virtual pool 1600 VP1.

Likewise, if a player initiates play on a 10 cent game, contributions from that wager affect virtual pools VP1 and VP2, in correspondence to 2 unit bets of a wager. (i.e., a 10 cent game is treated as a 5 cent game with 2 coins wagered). In FIG. 7, the progressive controller signals a 10 cent game wager event 1660. Two unit bets of wager are generated in correspondence to the 10 cent wager. One unit bet contribution 1641 is diverted through unit bet multiplier 1620 M1 and the resulting contribution value is summed into virtual pool VP1. The second unit bet contribution 1642 is diverted through unit bet multiplier 1621 M₂ and the resulting contribution is summed into virtual pool VP2.

Likewise, if a player initiates play on a 25 cent game, then contributions from that wager affect virtual pools VP1 through VP5, corresponding to a five unit bet. In this case, the first wager unit is passed through unit bet multiplier M1 and its resulting value added to virtual pool VP1. The second unit bet is passed through unit bet multiplier M2 and its resulting value is added to virtual pool VP2. In a likewise manner, the third through fifth unit bets are routed through their respective unit bet multipliers M3 through M5 respectively. The resulting values are added to their respective virtual pools VP3 through VP5 respectively.

In FIG. 7 of the multi-denomination progressive example, the process of grouping progressive contributions by considering each wager denomination to consist of unit bets is analogous to the method given for multi-coin game progressive awards outlined in the prior section. In terms of tracking and calculating the progressive contributions into the virtual pools, there is a difference, that is, wagers consisting of three and four unit bets are missing. These bets would correspond to 15 cent and 20 cent denominations, which in the example, are not part of the multi-denomination progressive link. We will discuss how the missing bet denominations affect typical calculations for making unit bet multipliers conform to a proportional progressive system as defined earlier.

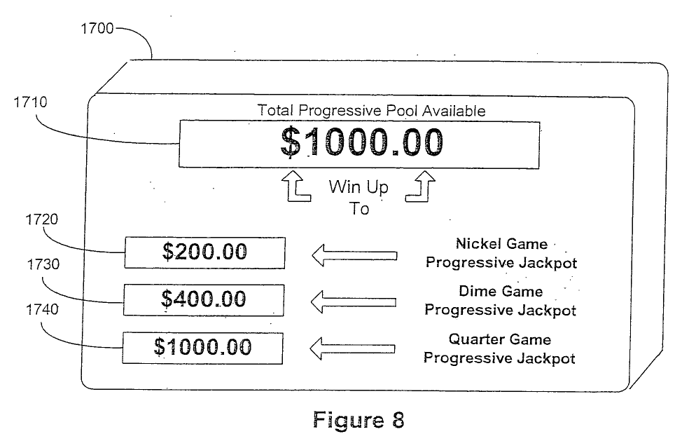

FIG. 8 shows how a progressive display 1700 might look for the example case. It should be understood that this is simply one possible method of displaying the progressive awards that are available. In FIG. 8, the total progressive jackpot pool 1710 is shown as a central value. The value displayed here would represent the maximum award that can be received. The maximum award 1710 is only available to 25 cent game players. Secondary display 1720 shows the progressive award available to players playing 5 cent games, and display 1730 shows the progressive award available to players playing 10 cent games. Secondary display 1740 is shown to clarify that the maximum value is available to 25 cent players in the example.

It should be noted that the actual monetary values shown in FIG. 8 are for illustration only; in practice, progressive pool values for each virtual pool usually differ from one another based upon game play history. However, virtual pools can be equal at the initial start-up of the system, since the base values of each virtual pool may be equal. Also, if an equal number of games of each wager type are played on a proportional system after initial start-up, or after a maximum coin jackpot hit, the virtual pools will be equal (i.e., assuming each base reset value is also the same).

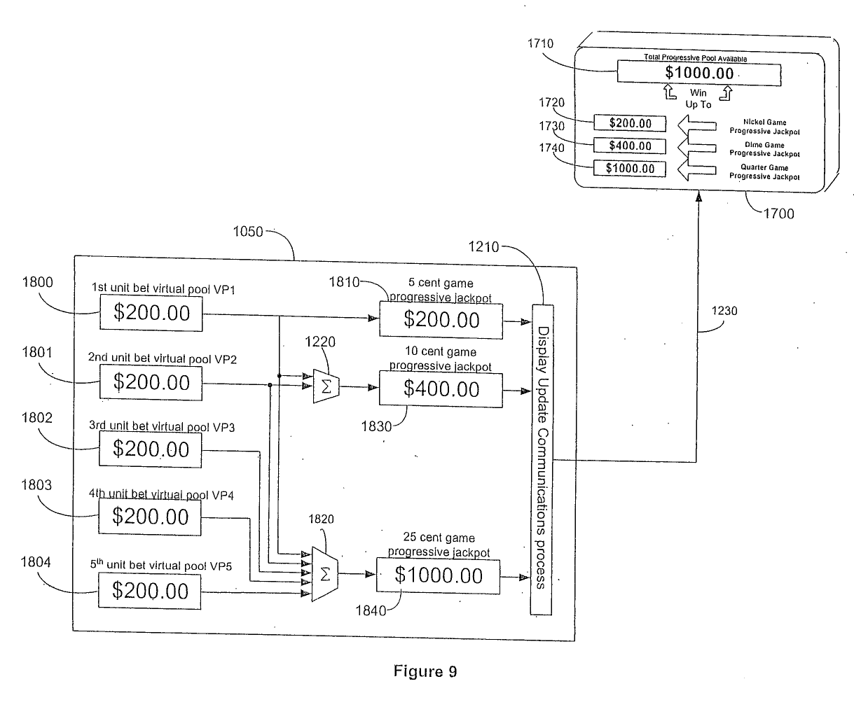

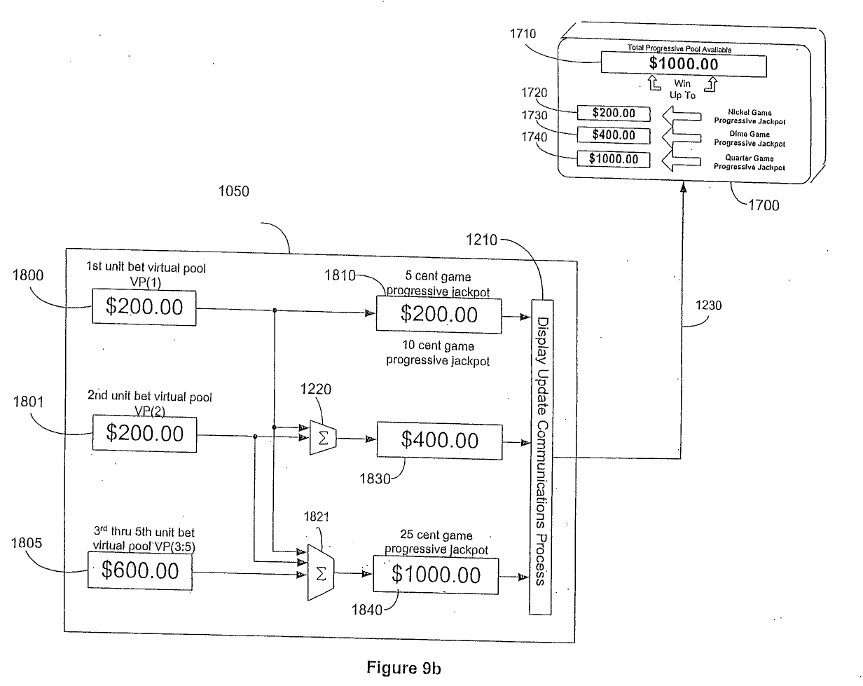

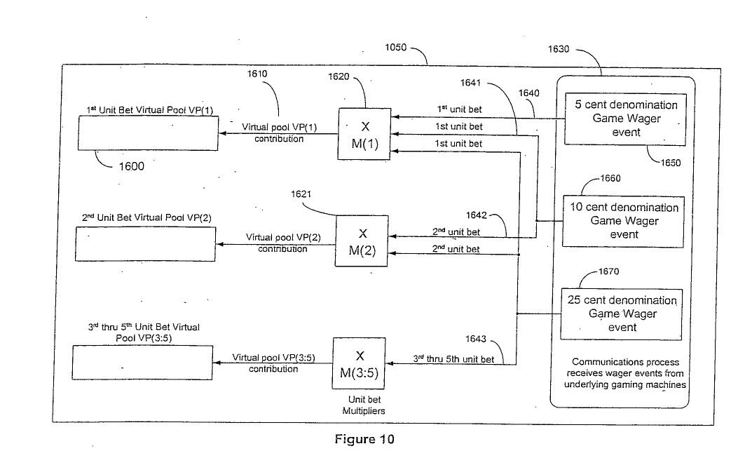

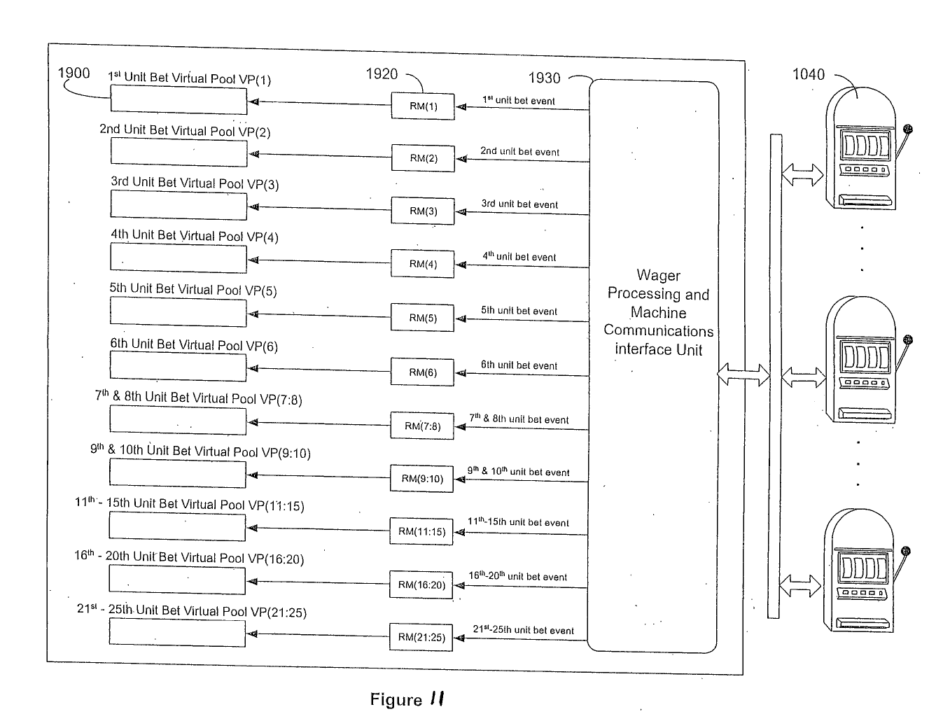

Similar to the method of the present invention for multi-coin progressives, FIG. 9 shows how the virtual pools VP1 through VP5 overlap to form the displayed progressive awards for each game denomination, as shown in FIG. 8. The progressive jackpot for the 5 cent game 1720 is formed using only contributions tallied by virtual pool 1800 VP1. Because the progressive controller 1050 in this embodiment would continuously calculate the current value of each jackpot value, an internal representation of the 5 cent progressive jackpot value 1720 is also shown as stored in memory, i.e., the current progressive jackpot register 1810. The 5 cent game jackpot value 1810 reflects only the sum of one virtual pool 1800, that pool tracking all contributions derived from the first unit bet of all wagers.

In FIG. 9, and by means of example, the 10 cent game progressive jackpot 1730 would also be calculated continuously by the progressive controller 1050, whose internal sum is shown stored in the current progressive jackpot value register 1830. Note that the 10 cent progressive jackpot is formed by summing the contents of virtual pool VP1 and VP2, which represents contributions from the first and second unit bets of each denomination wager. Note that this sum is made on a continuous basis, or at least whenever the value in virtual pool VP1 or VP2 has changed due to on-going contributions from game play wagers across the link.

Likewise, FIG. 9 shows how the 25 cent game progressive jackpot 1740 is formed. By means of example, the progressive controller 1050 adds the values contained in all five virtual pools together as seen by the five input summer 1820. The sum of all virtual pools VP1 through VP5 is then stored in the current progressive value register 1840 for 25 cent games. Therefore, the progressive value for 25 cent games is the sum of contributions formed by all unit bets of each wager. The communications processor unit 1210 routes the progressive jackpot information for all denominations via network 1230 to the progressive display device 1700 for display.

FIG. 9 shows that the wager contributions overlap in this optional embodiment. That is, the 5 cent wager contributions overlap 10 cent and 25 cent game contributions. Ten cent wager contributions overlap 5 cent and 25 cent game contributions, and 25 cent wager contributions overlap 5 cent and 10 cent contributions to the progressive pool. The amount of overlap of the contributions is in proportion to the number of common virtual pools of each jackpot. Furthermore, the progressive jackpots for larger denominations include contributions from games of smaller denomination. In other words, all progressive jackpot amounts of smaller wager denomination are a subset of the progressive jackpots of all larger wager denomination in the single coin wager example.

The overlap in this optional embodiment of the progressive contributions makes the method of the present invention more fair than the prior art. Each unit bet can be viewed as a “buy-in” for that respective virtual pool. As players increase their respective wager denomination, their respective jackpot is increased accordingly by an increased number of buy-ins of additional virtual pools. Since the chance of hitting the progressive jackpot is the same regardless of denomination, each player is playing for their fair share of the total progressive pool, where the total progressive pool is the sum of all virtual pools VP1 through VPN. When a player hits the jackpot, that player receives a jackpot with a value that is the sum of each virtual pool that was “bought in” at the instant of game play. Accordingly, the progressive jackpot will reset to its base value. The process of resetting the progressive jackpot of the present invention is explained later.

It is worth noting in the prior example that progressive awards corresponding to 3 unit bets and 4 unit bets are missing. The reason is that 15 cent and 20 cent wager denominations do not exist in the particular example. In this case, it is not necessary to track virtual pools VP3, VP4 and VP5 separately. These virtual pools may be combined into a single, yet larger virtual pool. The associated rate multipliers for VP3 through VP5 are also combined into one rate multiplier. The single rate multiplier is a mathematical reduction, but its value is increased by a factor of three in this case to adjust for the fact that 3 unit bets worth of progressive contribution are being tallied as opposed to one.

In FIG. 9B, the prior example from FIG. 9 is shown using the reduction described above. In the figure, a new terminology is introduced to identify each virtual pool. The three virtual pools are now known as VP1, VP2, and VP(3:5), the last syntax describing the virtual pool to be a combination of three unit bet virtual pools. The reduction is important to note since the virtual pools VP3 through VP5, as in the prior example of FIG. 7, will always contain the same number of unit bet contributions, and therefore, this fact will affect the relation for the rate multipliers of the multi-denomination system in order to achieve a proportional system as so defined.

As in the methods for multi-coin jackpots, in a “proportional” multi-denomination system, progressive jackpots grow at the same proportion to their respective wager size, assuming an equal number of all wager denominations is made.

In such an optional proportional progressive system, and the prior example, shown in reduced form in FIGS. 7B and 9B, the following relationship between rate multipliers, M1, M2, and M(3:5) are:
M₁×3=M₂×2=M_{(3:5)}/3 (Eqn 11)

In Eqn 11, the standard progression of factors ×3=×2=×1 (i.e., Eqn 2 for multi-coin case) accounts for the overlap of unit contributions to form progressive jackpots and also to the relative number of contributions made to each virtual pool, assuming the same number of bets of each denomination are made.

In Eqn 11, the factor of three dividing the term M(3:5) is included into the standard progression to account for the fact that the quarter denomination multiplier accounts for three unit bets. In this terminology, the multiplier is accounting for a “gap” of 3 unit bets.

A general relation between rate multipliers M1 through Mn which satisfies a proportional multi-denomination system is:
(M1×n)/G1=(M2×(n−1))/G2=(M3×(n−2))/G3= . . . =(Mn×1)/Gn (Eqn 11b)
where G=the gap number associated with each wager level, (i.e. the number of unit bets being tracked by the associated virtual pool), and n=total number of wager levels.

In FIG. 7B, a reduced method is shown for tracking progressive contributions in the example. In this illustration, the 25 cent wager event 1670 causes contributions to be made to each virtual pool; i.e., a contribution to virtual pool VP1, a contribution to VP2, and a contribution to VP(3:5). Unlike the VP1 and VP2 contribution, the contribution to VP(3:5) represents three unit bets of progressive contribution. The additional factor of three can be included into the rate multiplier itself, or a seperate factor may exist to account for the effect of three unit bets worth of progressive contribution. It should be noted that this distinction is not important, and any equivalent method may be used in actual implemention. For example, each progressive contribution associated with each rate multiplier may be calculated in advance, and added to each virtual pool in response to its associated unit wager having been made.

Although not necessary to the invention, for the purposes of this discussion, and in the equations used throughout, a single rate multiplier is used which includes any additional weighting to account for the number of unit bets worth of contribution being tracked. This generally simplifies the mathematics and explanations describing each optional method.

As an option, each rate multiplier is appropriately scaled to provide the actual dollar amount that is contributed to each respective virtual pool. This scale factor could be the same for all rate multipliers in order to satisfy Eqn 11 in the example. However, this is not a limitation of the present invention. By means of example, a separate scale factor is used and is denoted as S in equation 12 below.

In the present invention, the maximum increment rate is considered, Rmax; it is the total percentage contribution made to the progressive when the maximum wager is made (which is 25 cents, the greatest denomination supported by the system in the example.) The increment rate is often considered as a percentage of the wager, although it may also be considered in other terms, such as a fixed, incremental amount of money in another optional embodiment.

In the example, R_{$max} is the total contribution made by the maximum size wager, expressed as a fixed dollar amount using:
R_{$max}=(M₁+M₂+M_{(3:5)})*S Eqn 12)
where S is overall scale factor, and M(3:5) is normalized to 1 using Eqn 11.

Rmax is the percentage increase, or percentage increment, represented by R_{$max}. This is given by:
Rmax=R_{$max}/(max wager) (Eqn 12B)

Therefore, if the target increment rate is 1%, then Rmax is optionally set to 0.01, and using Eqn 11 and Eqn 12, the following is calculated:

Setting, in this example, the largest rate multiplier M(3:5)=1, then using Eqn 11,
M1=0.11111 (Eqn 12C)
M2=0.1667
M(3:5)=1
Therefore, using Eqn 12:
Rmax=0.01=(((0.111)+(0.1667)+(1))*S)/0.25 (Eqn 13)
And therefore, the overall scale factor, S, is approximately
S=0.001957.

In multi-denomination method, M(n) is the last of (n) number of rate multipliers. The total number of rate multipliers is not neccesarily the total number of unit bets of the maximum wager. In fact, the number of rate multipliers now depends on how many distinct wagers can be placed in the multi-denomination system of the present invention.

For this example, rate multipliers are denoted in a sequential fashion, in ascending order of value. For example, the first rate multiplier is associated with the first wager size, which is one nickel in the prior example. The third rate multiplier is associated with the quarter denomination wager in the example. Therefore, n=3, since there are only three rate multipliers in this example corresponding to three possible wager sizes.

As noted earlier, the scale factor S can be incorporated into each rate multiplier M(n) shown in FIGS. 7 and 7B to provide the actual dollar amount contributed to each virtual pool VP(n) as one option of the actual embodiment.

General forms for Eqns 11 and 12 can be derived using the examples shown. Eqns 11 and 12 define one option of calculating multiplier rates for the multi-denomination progressive system of the present invention. It should be clear to those practiced in the art that other weightings for rate multipliers are possible; alternative rate multiplier values can further affect the rate of growth and relative distribution of progressive prizes for each associated denomination.

It should be recognized that the multi-coin progressive method and the multi-denomination method differ in a key respect, that is, the multi-denomination method may be applied to the prior art practice of offering progressive awards to max coin players only. That is, in an optional embodiment, the multi-denomination method tracks a progressive value for each denomination type, but only awards the progressive jackpot if the player is wagering max coin for their respective denomination. In this case, players wagering less than the maximum number of coins may still contribute to the progressive jackpot, but will not be eligible to collect that jackpot.

In such an optional embodiment, if the system above collects progressive contributions from non-eligible players, the contributions from each non max-coin wager are added to the jackpot, as in prior art systems. In the case of the present invention, a plurality of virtual pools are managed, each pool associated with a specific wager denomination and “level” of buy-in. Therefore, there are two options described for accumulating contributions from non-max coin wagers, as discussed below. Other additional options also exist.

Continuing the example, the system tends to promote max coin wagers, while tending to discourage wagers that are not max coin, but still valued at or above any other max coin wager value. For example, if max coin is set at 5 coins, then the system of the example encourages max coin play on Nickels, but discourages single coin play of one quarter, since it is generally better to be eligible for the progressive using Nickels at a wager level of 25 cents, then not be eligible for a progressive and still wagering 25 cents (one quarter). Similarly, it is generally better to wager max coin of dimes denomination, totalling 50 cents, then wager 2 quarters at 50 cents and not be eligible for a progressive. Therefore, the system discourages anything but the max coin bet for the largest denomination, yet offers progressive awards for max coin bets of smaller denominations, therefore promoting max coin play for all wager denominations.

One possible long term effect of the system could be to make maximum sized denominations statistically better payback than all smaller sized denomination jackpots assuming an equal number and size of wagers for each denomination.

In one option of the present invention, wagers not meeting max coin only affect the virtual pool associated to the denomination of the wager. The progressive rate multiplier associated to that virtual pool is generally used, although this is not a requirement of the invention. In this option, coin wagers not meeting max coin promote same denomination jackpots. Therefore, in the example, if there are a particularly large number of, say, non max coin quarter wagers as compared to other non max coin bets of all smaller denominations, then the quarter jackpot, and virtual pool VP(3:5), will benefit versus jackpots of all lower denominations. Likewise, wagers from non max-coin dime players will benefit only VP2, which in turn benefits only dime and quarter jackpots. Lastly, wagers from non max coin nickel players will contribute to only VP1, benefiting all jackpots. In this option, non max coin wagers benefit mostly the jackpot associated with its denomination.

In another option of the present invention, all contributions from non max-coin wagers affect multiple virtual pools in a manner analogous to multi-coin progressives. In this case, the non max-coin wager value is represented as a number of unit coin bets, regardless of denomination type. Each unit bet follows the path given in FIG. 7, and affects its virtual pool accordingly. Therefore, non max coin wagers can affect all virtual pools. In this case, tracking separate unit bets as in FIG. 7 is required, or when using the method described by FIG. 7B, supporting a separate unit bet scale factor for multipliers associated with wager size gaps, such as M(3:5) in the example. In this alternate method, non max coin wagers can affect more than one virtual pool.

In yet another option, it should be noted that a secondary, or alternate set of rate multipliers can be used to apply contributions from non-max coin bets to each associated virtual pool.

Multi-Denomination Progressive Jackpot Resets

In most prior art systems, the reset value for a progressive jackpot is representative of the normal pay the underlying game would pay for that particular game outcome without a progressive jackpot. For example, if a video poker game normally pays 4000 coins for a royal flush (without a progressive), then the progressive jackpot version of that game outcome would reset back to 4000 coins after a progressive jackpot for the royal flush has been hit. Normally, the underlying base award, 4000 coins in this case, is converted to a dollar amount in practice, and displayed as the progressive jackpot value, although this is not a limitation of the present invention.

In the method of the present invention, progressive resets may differ in several respects. For one, the reset process only affects virtual pools VP1 through VPX, where x is the number of unit bet wagers wagered on the game that hit the progressive jackpot. Secondly, the progressive jackpot may not reset for all wager or denomination sizes if the progressive jackpot is not hit by the maximum denomination and wager size.

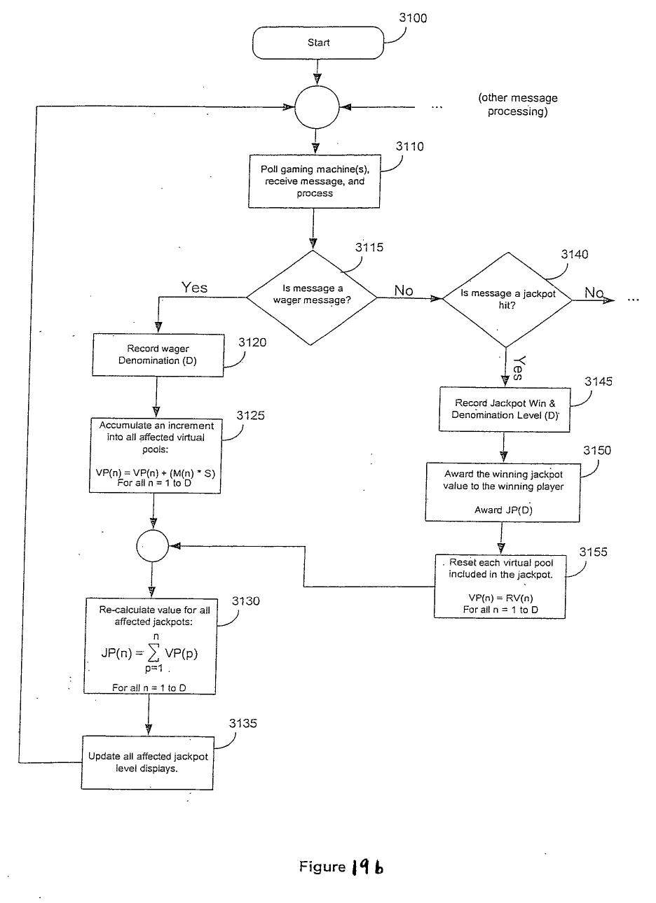

By means of a flow chart in FIG. 19B, the basic multi-denomination progressive reset process can be described. In FIG. 19B, a message is processed starting at decision block 3115. If the message is not a wager, flow continues to decision block 3140 to determine if the message is a winning jackpot. If so, flow is diverted to process 3145, where the jackpot level, i.e., the wager denomination, is recorded. In the next process 3150, the jackpot award value is locked, and awarded to the winning player. The award value is that jackpot value associated to the particular denomination D of the wager that hit the jackpot. In the next process 3155, the virtual pools associated with the jackpot award value are reset by loading each virtual pool VPn by its reset value RVn. In process 3130 of FIG. 19B, the value for all affected jackpots are then re-calculated, since the jackpot values have now changed as a result of a prize being awarded. In process 3135, the values for all affected jackpots are refreshed to all jackpot displays.

It should be noted that the flow chart of FIG. 19B is only an example embodiment of the present invention. Many alterations of the flow chart exist which accomplish essentially the same thing. For example, the process of updating all affected jackpots 3135 need not be processed every time through the loops shown in FIG. 19B. As an alternative, the display update process may lag behind the other processes, and even operate out of synchronization with other processes. However, in an optional embodiment, the displays can be updated as a result of any change in any jackpot value, and therefore, it is included as a step in each loop of processing wagers and jackpot hits. The process of updating each jackpot value can also lag behind the process of collecting contributions into virtual pools in a like manner. However, jackpot values should be calculated prior to any jackpot award being awarded.

Basic notation used to describe the operations of the data arrays, i.e., rate multiplier array 2230, virtual pool array 2250, jackpot awards 2270, and reset values 2280 of FIG. 5, are used in the flow chart of FIG. 19B. A simple array indexing notation is used. For example, the summation of virtual pools VP(n), n=1 to N, indicates that all virtual pools of virtual pool array 2250, whose indexes include 1 through N, should be summed. Since this example covers the multi-denomination method of the present invention, the basic array index is associated to the range of different wager denominations supported. The index determines which series of data elements within each array is processed.

It should be noted the reset value may be contingent on whether the progressive system is programmed to pay in addition to the normal base pay, or whether the progressive jackpot is paid in lieu of the normal base pay. For example, the reset value may be programmed as zero if the system is so programmed to include any normal payouts from the underlying game paytable in addition to the progressive jackpot amount. Alternatively, if the progressive system is so programmed to pay in lieu of the underlying base game, i.e., the progressive will replace the underlying games entire payment; therefore the reset value will typically be non-zero, and will normally be equal to the normal base pay of the underlying game. The distinction is really a matter of system configuration and does not impact the method of the present invention. It should be clearly noted that method of the present invention handles reset amounts of any type of configuration required.

It is also well known in the art that the progressive reset value need not be the normal base pay. For example, the reset value could be higher than the normal base pay; in this case, the overall payback percentage of the underlying game is further affected by this modification. In other cases, the progressive controller can manage a secondary reset value that is restored to the progressive value immediately after a player hits the jackpot. It is to be understood that the method of the present invention can take advantage of such additional features without changing the underlying method described herein.

Mixed Systems

A mixed multi-coin and multi-denomination system is yet a third invention discussed in this document. Such a system will be herein referred to as a “mixed” system.

The mixed system borrows on methods of both the multi-coin progressive system and multi-denomination progressive system. However, the methods are applied in combination, and therefore, there are key differences in the method of the mixed system.

There are several optional yet basic ways to combine the multi-coin and multi-denomination methods. Both methods require a normalized bet unit, or GCD (greatest common divisor) as introduced in a prior section. The first method tallies and processes wagers in accordance to the value of the wager, not denomination. This method also imposes a completely overlapping jackpot pool. The second method processes wagers on both denomination and wager size, and supports a partially overlapping jackpot pool.

Completely Overlapped Mixed System Method:

As in the earlier example, consider the case of linking games of unlike denomination, for example, a nickel, dime and quarter denomination game. We consider that each game is also a multi-coin game, therefore, each game allows up to 5 coins bet for example. In a typical case, each game supports the same, fixed number of coins for max coin wagers, although this is not a limitation of the present invention. For example, the system of the present invention can support a version having unlimited coin betting, as well as different levels of coin betting between games linked in the progressive. (As per definition, the largest coin wager that can be placed on any game is referred to as “max coin bet”.)

In this example, the GCD, or unit bet, is again 5 cents, since a 5 cent wager is the largest sized wager that evenly divides all other wagers. In the first option of the mixed system, each successive level in betting value includes the player into each successive virtual pool that is managed by the progressive controller. If the player wins the progressive prize, he or she is awarded all virtual pools associated with equal and smaller sized wagers. Therefore, this option of the mixed progressive system tracks unit bets and wager size regardless of denomination type. In such an example, a single quarter player would play for the same progressive prize as a player wagering 5 nickels. This system is further described as “completely overlapping”, since the progressive value of all larger wagers overlaps all progressive values of smaller wager size. From this point, the system is similar to the multi-coin method described earlier.

Because the system is still multi-denomination in nature, the minimum number of virtual pools required is related to the total number of supported wager sizes. To determine the number of virtual pools required in the example, suppose there are no gaps of wager size between 5 and 30 cents; furthermore, the dimes player can also bet 40 and 50 cent wagers, while the quarter player can make additional wagers of $0.75, $1.00, and $1.25.

Therefore, at least 11 virtual pools would be managed in the example. Note however, that the system can use 25, or any other number, of virtual pools in an optional embodiment. (25 is the number of unit bets of the largest wager in the example). In this optional embodiment, the system would be represented in much the same way as FIG. 7 and FIG. 9 show. In this case, 25 virtual pools, each representing an incremental unit of wager of 5 cents. It should be noted that there may be other ways to represent the same basic ideas, but these are not discussed here.

As noted earlier, a method and representation using the minimum number of virtual pools is preferred when explaning associated mathematics of the system. Therefore, in the example, 11 virtual pools will be used. An important part of the system is the relative ratio of the rate multipliers, which determine the relative contribution made for each wager processed by the system. When using the minimum number of rate multipliers, some rate multipliers may account for a different number of unit bets due to gaps in the wager size such as when certain wager sizes are not supported.

For the example, in order to achieve a proportional jackpot system as defined, the following relation would be satisfied:
M₁×11=M₂×10=M₃×9=M₄×8=M₅×7=M₆×6=(M_{7:8}×5)/2=(M_{9:10}×4)/2=(M_{11:15}×3)/5=(M_{16:20}×2)/5=(M_{21:25})/5

Note, however, that any set of rate multipliers may be used. The proportional system simply provides a theoretical condition for a proportional rate of growth given that all wager sizes occur equally. Other sets of rate multipliers can achieve alternate objectives, such as ensuring that all contributions from each wager level are equal, for example. As another example, the rate multipliers may be adjusted to provide a proportional rate of progressive growth given a non-even number of all wager types (i.e., rate multipliers can be adjusted to compensate for a non-even distribution of wager types.).

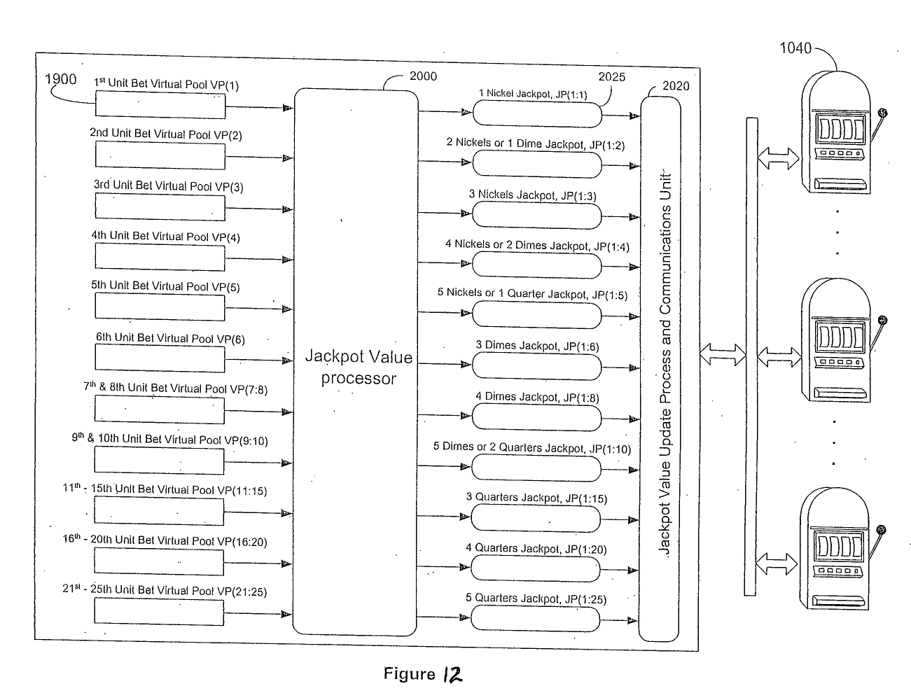

In the example, and using FIG. 11, eleven rate multipliers are supported, one associated to each of 11 virtual pools. The virtual pools are denoted by notation used for the multi-denomination method to indicate potential gaps in wager size. For example, the virtual pools in the example are:

TABLE 1

| | |
|---|---|
| VP₁ | -> tracks 1^{st} unit bet contributions, associated to nickel wager |
| VP₂ | -> tracks 2^{nd} unit bet, 2 nickels or one dime wager |
| VP₃ | -> tracks 3^{rd} unit bet, 3 nickel bets |
| VP₄ | -> tracks 4^{th} unit bet, 4 nickels or 2 dimes |
| VP₅ | -> tracks 5^{th} unit bet, 5 nickels or one quarter |
| VP₆ | -> tracks 6^{th} unit bet, 3 dimes |
| VP_{7:8} | -> tracks 7^{th} and 8^{th} unit bet, 4 dimes |
| VP_{9:10} | -> tracks 9^{th} and 10^{th} unit bet, 5 dimes or 2 quarters |
| VP_{11:15} | -> tracks 11^{th} through 15^{th} unit bet, 3 quarters |
| VP_{16:20} | -> tracks 16^{th} through 20^{th} unit bet, 4 quarters |
| VP_{21:25} | -> tracks 21^{st} through 25^{th} unit bet, 5 quarters |

Note that each virtual pool VPn above accumulates contributions from a particular nth unit bet, as shown in FIG. 11, and as defined in the section for multi-coin and multi-denomination methods. However, also note the virtual pool can be associated with a particular betting level, in terms of real dollars. For example, in Table 1, VP3 accumulates contributions from the 3^{rd} unit bet of all wagers that either equal or exceed the three nickel wager level. Therefore, VP3 is associated to the 3 coin nickel wager, but it actually tracks the third unit bet contribution of every wager. To be specific about the association, the 3 coin nickel wager represents the threshold level of wagering which essentially triggers contributions into the VP3 pool.

In FIG. 11, the notation RMn is used to label each of the eleven rate multipliers (RM) of the example. Like the virtual pools, the same notation is used to indicate potential gaps in betting size. (Gaps in betting size exist when all combinations of denomination and multi-coin increment wagers fail to cover every incremental unit bet of wagering theoretically possible.) Gaps in wagering size imply that more than one unit bet worth of contribution is being accounted for by the associated virtual pool. Therefore, the rate multiplier must also account for more than one unit bet worth of wager being processed. The additional factor can be merged into the rate multiplier itself, which is the standard used to describe the methods herein, or it may exist as a separate factor applied as a second stage process.

FIG. 11 illustrates one option of how wager contributions are tracked and tallied. It is similar to FIG. 7B except less detail is shown regarding the path of the wagers collected by the gaming devices, and the triggering, or tallying, of the specific virtual pools in response to each wager. In one optional embodiment, the method of the present invention relies on software and/or firmware to implement the required functions of the invention. Therefore, in FIG. 11, Wager Processing and Machine Communications Unit 1930 is shown in block form to indicate the overall function, which could be implemented as a software routine.

The Wager Processing and Machine Communications Unit 1930 is responsible for triggering the proper number of virtual pools to be accumulated with their respective contributions. In the example, a particular wager will trigger accumulation to all virtual pools with an associated value less than or equal to the wager itself. For example, a 3 nickel bet will trigger contributions to Virtual Pools VP(1), VP(2), and VP(3). The 3 nickel bet is associated to the level of virtual pool VP(3), which tracks the third unit bet of each wager. This wager is 15 cents, so it also trigges accumulation to virtual pools associated with 10 cents and 5 cent wagers.

In FIG. 11, rate multipliers RM(n) are shown which either represent fixed monetary values (“dollar increments”) added to its associated virtual pool, or percentage rates applied to unit bet values and added to its associated virtual pool. They are essentially equivalent. As previously discussed, since virtual pools may track more than one unit bets worth of contribution, rate multipliers may be scaled appropriately to compensate for the correct contribution amount, depending on embodiment.

Regardless of which options are chosen for embodiment, multiplier rate data is typically stored as as array in storage RAM, ROM or disk within a computer system. In this optional emodiment, the rate multiplier data could be stored as pre-calculated progressive increments or percentage rates to be made in real time. If the rate multiplier data is formatted as predefined, fixed value increments, then the increment value is added to the associated virtual pool. If the rate multiplier is a percentage, then the proper unit bet amount is multiplied by the rate value to yield the contribution value added to the virtual pool.

It should be noted that other optional methods of calculation and tracking are possible. For example, the system need only track unit bets themselves in the virtual pools. Thus, a counter of each unit bet will yeild the associated virtual pool value when multiplied by its rate multiplier. In this case, the rate multiplier is applied after the process of tallying, which provides the value of each virtual pool. These values can be combined to create values for each progressive jackpot supported.

Calculation of the jackpot values is shown in FIG. 12. This figure is similar to FIG. 9B which illustrates how the virtual pools are combined to form each progressive jackpot “sub-level” (i.e., or simply “level”). In the previous FIG. 9B, summers 1220 were used to illustrate the jackpot summing process. This type of illustration is cumbersome when the number of virtual pools becomes large. Therefore, FIG. 12 illustrates the “summing” process using the Jackpot Value Processor 2000 block. In an optional embodiment, the Jackpot Value Processor 2000 is a software module programmed to sum each jackpot value, or level offered in the system. The value of each jackpot level is the sum of each virtual pool equal to or less than the level associated with the jackpot. This is only optional, however.

In FIG. 12, a new jackpot notation is also introduced. The notation JP(1:n) desigates the range of virtual pools summed into that particular jackpot value (i.e, jackpot wager level). For example, JP(1:5) indicates a jackpot value which is the sum of virtual pools VP1 through VP5. The notation JP(1:25) is the sum of all virtual pools in the example system. In practice, actual jackpot values are typically calculated in real time to provide up-to-date information to all linked gaming devices and progressive displays. Using this notation and FIG. 12, it is easy to understand how each jackpot level is calculated in the example of a completely overlapped mixed progressive system.

Table 2 is copy of a spreadsheet showing example calculations of the simple example.

It should be noted that the mixed progressive of the present invention must adapt to a multitude of different configurations. To accomplish this, the allocation of memory for virtual pools, local jackpot value storage, etc., is typically a dynamic process. This allows the system to be flexible and configurable. Flexibility could also be provided by user menus, and other user controls to simplify the process of configuring the controller in its intended application.

Mixed System, Partially Overlapped Example

Another option for the mixed multi-coin and multi-denomination method of the present invention is described next. This option is the partially over-lapped, matrix method. The system may also be described as a dual axis method. In this method, two scales of rate multipliers are used. For example, one scale of rate multipliers can account for mutli-coin wagering, while another scale can account for multi-denomination linking of games.

For example, consider the example of linking games of three different denominations, i.e., a nickel, dime and quarter game. Further consider each game supports a 5 coin maximum wager, so each game is also a coin multiplier type. Therefore, as in the prior example, the progressive link is to support both multi-coin progressive wagers, as well as multi-denomination progressive wagers.

For an optional “proportional” system, each rate multiplier scale must satisfy its particular relation, as already defined in prior sections. It is also generally easier to illustrate the method using “normalized” rate multiplier scales, that is, make the greatest rate multiplier (of each scale) equal to 1. In this way, each next smaller rate multiplier is a fraction less than one. By combining two scales of normalized rate multipliers into a grid pattern, thereby representing all possible bet combinations, a unique rate multiplier matrix is created. Each entry of the rate multiplier matrix represents the product of each coresponding rate multiplier from each scale. In this manner, a single overall scale factor S can be used to convert each entry of the normalized rate multiplier table into actual monetary contributions added to each virtual pool.

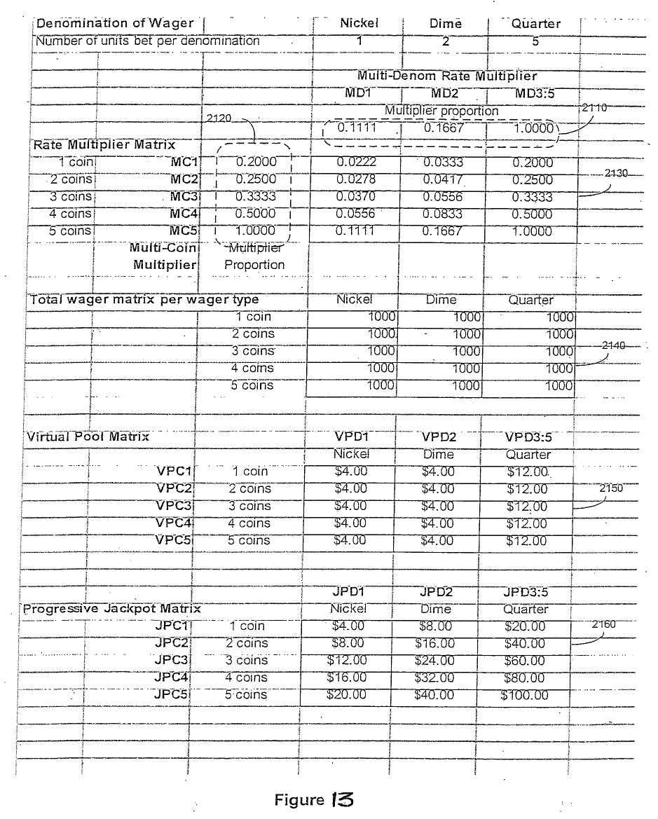

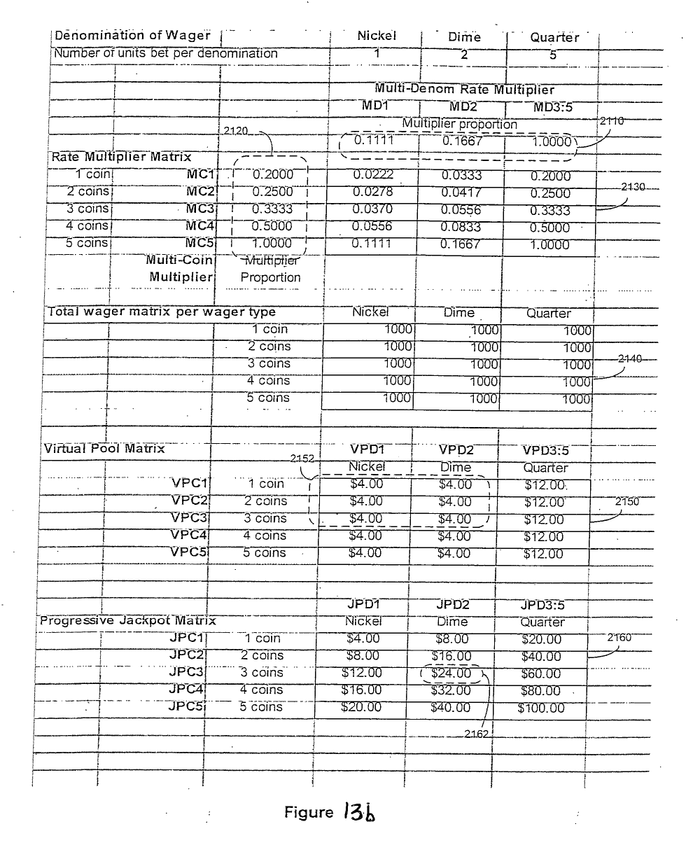

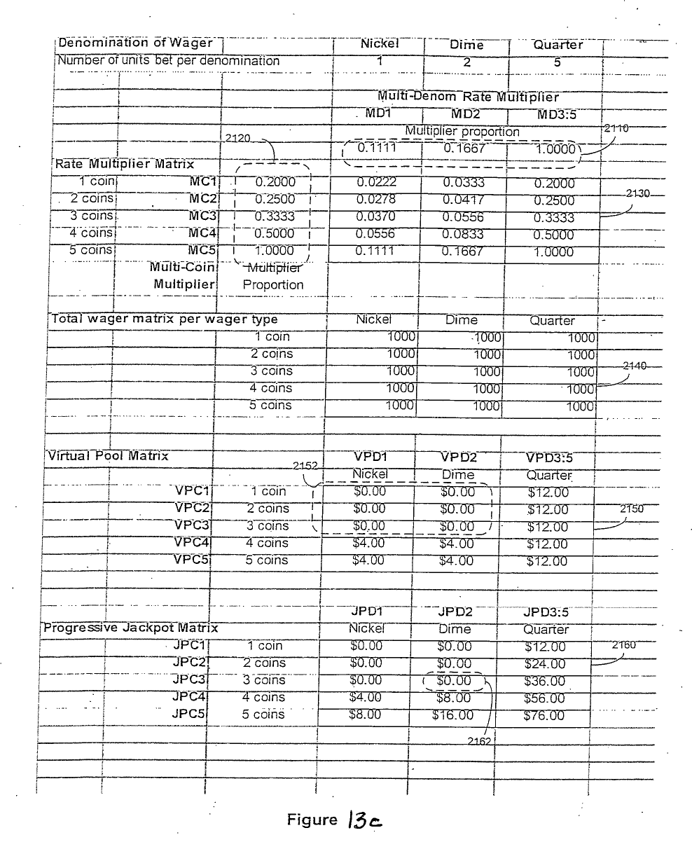

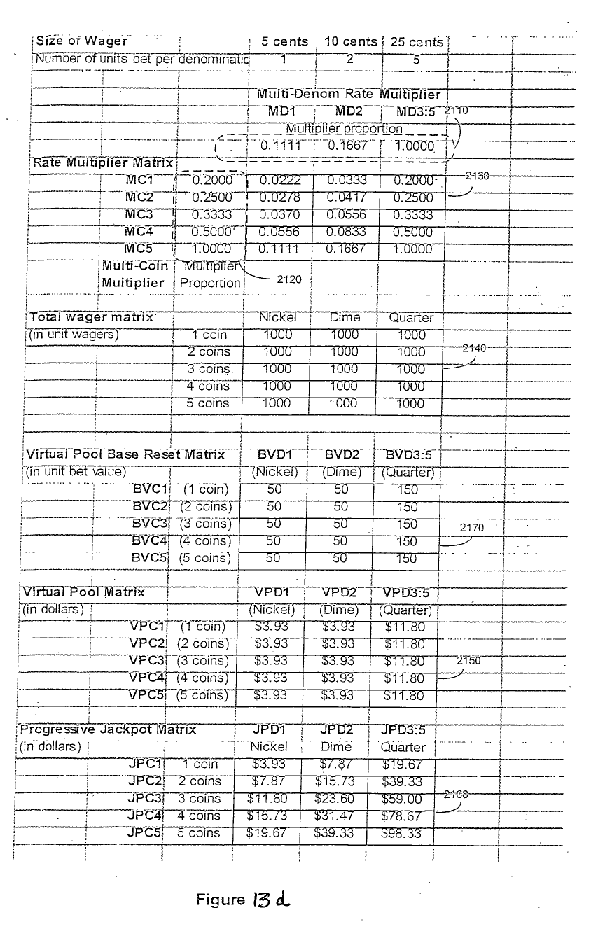

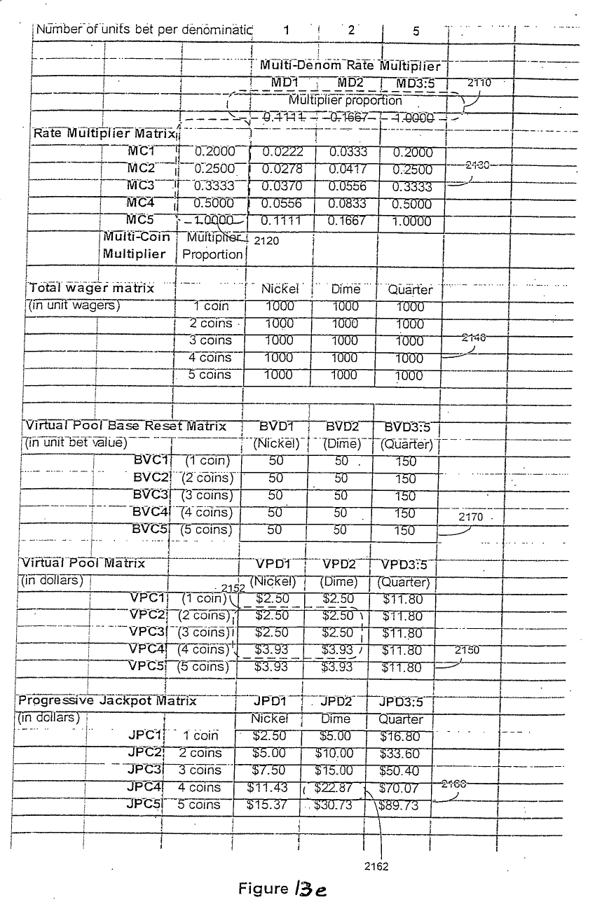

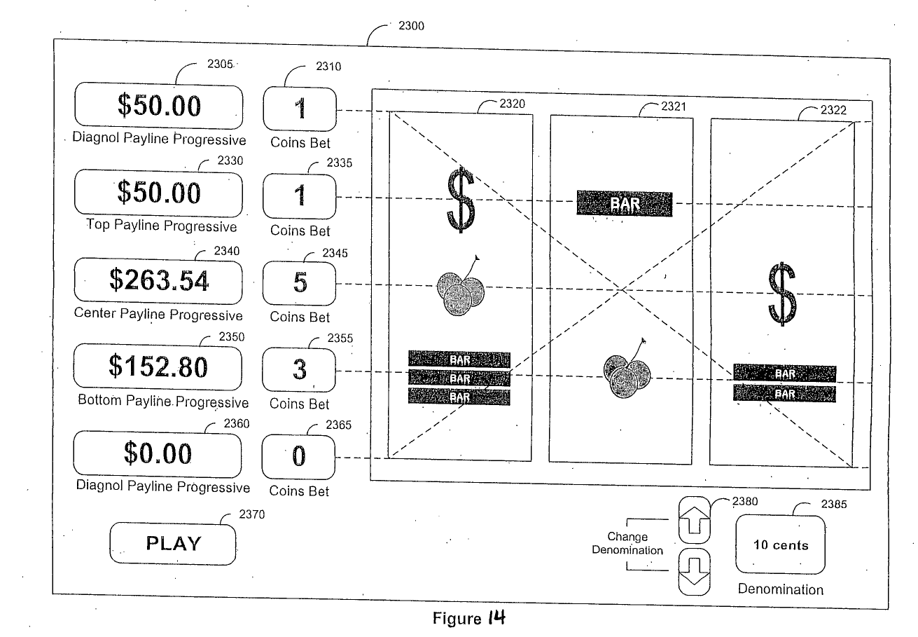

One way to describe the rate multiplier matrix is to actually use a matrix table 2130, as done in FIG. 13. The rate multiplier table 2130 uses a scale on each axis. The multi-denomination rate multiplier scale 2110 is along the horizontal axis. The multi-coin rate multiplier scale is along the vertical axis, as shown in FIG. 13 in the example. Each cell of the rate multiplier is derived by multiplying the corresponding rate multiplier from each axis. For example, the rate multiplier for a max-coin quarter wager is 1.0, since the 5 coin rate multiplier is equal to one, and so is the quarter multi-denomination rate multiplier. The rate multiplier for a 3 coin nickel bet is shown as 0.0370 in FIG. 13.

Also shown in FIG. 13 is a wager matrix table. This table is simply a means to introduce data into a spreadsheet model describing specific details of the invention. (However, in an optional embodiment, a wager matrix table can be used to track unit wagers of each type, and even convert such wager occurances into virtual pool values, for example.) The wager matrix table represents the total wagers of each wager combination tallied by the example spreadsheet. In FIG. 13, 1000 wagers of each supported combination have been entered into the example spreadsheet. Not shown in FIG. 13 is the processing of wagers in real time, such as the Wager Processing Unit 1930 of FIG. 11. This process could be responsible for tallying the appropriate virtual pools according to each wager combination received for the gaming machine network. Note that this option of the mixed system distinguishes wagers based on both coin multiplier and denomination of the wager.

In the Wager processing unit of the partially overlapped mixed system, virtual pools could receive a contribution from a wager if they are associated to a wager of equal or less coin multiplier, and equal or less denomination type. For example, a virtual pool associated with a 2 coin nickel bet is contributed to by a three coin dime wager, but not a one coin dime wager in this option of the mixed system.

Since fifteen rate multipliers are used in the example, we can define 15 virtual pools, optionally formatted in a matrix table. In FIG. 13, and according to the example, a virtual pool matrix 2150 is shown. Note that proportional values are shown in each cell of the virtual pool matrix 2150 by means of example only. In practice, each cell, hence each virtual pool, could contain a value that may not neccesarily be in proportion to any other virtual pool. However, FIG. 13 shows a steady state rate of growth for each virtual pool using the assumed proportional system, and assuming an even number of each wager combination without any history of jackpots.

Note that this version of the mixed method tracks a virtual pool associated to each wager combination, as opposed to each wager level, as in the prior option for mixed systems. This is an important difference. This option of the mixed progressive system supports 15 different wager combinations, each wager combination associated with a distinct virtual pool, and having its own associated progressive jackpot. For example, the jackpot pool for a single quarter wager and a 5 nickel wager are now distinct and quite separate. In fact, these two jackpots only overlap at the single nickel wager level. They are not completely overlapped, only partially overlapped.

In FIG. 13, a jackpot value matrix 2160 is shown with values inserted for means of this example. Note that the largest jackpot value is awarded for max coin quarter players in the example. (Follow the max coin row and the max denomination column to the corresponding jackpot value cell in the jackpot value matrix). Also note that while some jackpots, such as a 5 coin nickel and a one coin quarter wager, have the same proportional value in the example, they need not neccesarily be the same, and in general, will not be identical as the system processes wagers in practice.

The partially overlapped matrix method differs from the prior mixed method option in the way jackpot sums are overlapped. For one, max coin players are partially protected from players wagering different denominations but not max-coin. This is not the case in the optional embodiment of a mixed method discussed earlier. In that option, a single quarter progressive jackpot would clear the 5 coin nickel player jackpot since both jackpots are one in the same. In the mixed matrix system option, a 5 coin nickel player only shares the first virtual pool VP(D1:C1) with a single coin quarter player. Therefore, a player hitting the progressive jackpot with a single quarter wager would only subtract the value contained in virtual pool VP(D1:C1) from the max coin nickel jackpot. In the case of FIG. 13, only $4.00 would be subtracted from the existing $20.00 jackpot, (assuming all base reset values for the virtual pools is zero).

The partial overlapping may be advantageous in certain instances. For example, if special incentives are provided for max coin play by the underlying game itself, it may help to use a virtual pool matrix and provide jackpot seperation between different denominations of play. This option for mixed progressive systems could work well with denominations chosen which create gaps in wagering level.

Note that the jackpot matrix table 2160 in FIG. 13 illustrates how each axis could influence the proportion of the progressive jackpot pay level. For example, the jackpot value for a 3 coin dime bet is shown in cell JP(D2:C3). This cell shows a value of $24.00 by means of example. If one traverses the matrix table along the vertical axis, the relative value of the progressive jackpot award increases or decreases in proportion to the coin multiplier scale. If one traverses the jackpot matrix table in a horizontal direction, the relative value of the progressive jackpot award increases or decreases in proportion to the wager denomination scale.

In this option, each jackpot value is calculated by summing all virtual pools in the corresponding virtual pool matrix with an equal or lesser coin multiplier wager, and equal or lessor wager denomination type. This condition creates a small rectangle worth of virtual pools to be summed, starting with the virtual pool associated to the jackpot level as the lower right most corner, and the VP(D1:C1) cell as the upper leftmost most corner in FIG. 13.

Thus, the jackpot value at JP(D1:C1) is simply VP(D1:C1), i.e., the jackpot for a single nickel wager. The jackpot value at JP(C5:D3) is the highest jackpot value supported in the example, associated to the max coin quarter wager. This value is a summation of all virtual pools. The jackpot value associated with a 3 dime wager is JP(D2:C3); this jackpot is a summation of all blocks bounded by this position and VP(D1:C1).

Using FIG. 13B, the 3 dime wager jackpot pool 2162 is represented by cell JP(D2:C3), i.e., the second denomination, third coin wager cell. This jackpot is formed by summing all virtual pools 2152. As shown in FIG. 13B, virtual pools 2152 represent all virtual pools associated to wagers having equal or less denomination, and equal or less coins wagered than the 3 dime wager in the example.

If the 3 dime wager hits the progressive jackpot, the value of $24.00 is awarded in the example, and all virtual pools 2152 will be set to their base amount, which is zero in the example, and shown in FIG. 13C. Note that resetting all contributing virtual pools 2152 in turn resets the 3 dime progressive jackpot of the example. Note that the value of the virtual pools can be set to any value, although, zero is shown to simplify the example.

If FIG. 13D, a base value reset matrix 2170 is shown as an option for the example. The base value reset matrix contains the reset value associated with each virtual pool VP in the Virtual Pool matrix 2150. In this example, it is assumed that non-zero reset values are tracked by the controller, for example, to pay progressive jackpots in lieu of the underlying game payout. In FIG. 13D, the reset values are represented as single unit bets, however, any format or number may be used. In FIG. 13D, and by means of example, the virtual pools contain the value of their associated reset value in addition to contributions summed from wagers processed using the rate multiplier matrix 2130. This method works as long as the underlying games paytables are linear multipliers. If not, then one option contemplates tracking only the progressive contributions, and allowing the game to pay progressive jackpots as an additional amount to the underlying pay-table.

In FIG. 13E, a snapshot is represented at a moment just after a jackpot has been awarded. In the example, a 3 dime wager wins the progressive jackpot. The 3 dime jackpot value 2162 now resets back to $15.00, which is the summation of all virtual pools shown in the dotted circle 2152. Actually, the jackpot value is not directly reset, but simply reflects the fact that the virtual pools have been reset to their “base” values. The value used to reset each virtual pool is optionally non-zero, and in the case of the example of FIG. 13E, a virtual pool base reset matrix 2170 is used to store the value to be loaded into each affected virtual pool. If necessary, the relative units between tables could be translated, however, the overall effect is to establish the correct base pay of the underlying game for each jackpot cleared. This is possible if the underlying pay-table for the progressive award combination is a coin multiplier.

It should be noted that other methods can be used to track non-zero base reset values. For example, base values need not be loaded into their respective virtual pool after a jackpot occurs as in the example of FIG. 13E. Instead, in an optional embodiment, base reset values may be stored separately, and summed into their respective virtual pools when determining the value of jackpots.

In any case, it should be noted that virtual pools are optionally reset after a jackpot, not the jackpot values themselves. This contrasts with the prior art method of resetting jackpot values directly. However, when supporting non-zero reset values, the reset values can be loaded into the virtual pools for accumulation, or alternately (and optionally) stored separately and combined directly with virtual pools, or combined directly with jackpot values, or both. By storing reset values separately, and adding them directly into their associated jackpot values directly, non proportional pay-tables can be tracked and supported.

In the examples of FIGS. 13, 13B, 13C, through 13E, the matrix layout of the rate multipliers, virtual pools, jackpot awards, and reset values, are also considered “arrays”, and are essentially equivalent to the rate multiplier array 2230, virtual pool array 2250, jackpot prize array 2270, and reset value array 2280 of FIG. 5 respectively. However, in this optional embodiment, the arrays have two indexes, one associated with the denomination of the wager, and another associated with the coin multiplier of the wager.

Flow Charts of the Methods

Flowcharts are provided as an additional means to explain the methods of the present invention. It should be noted that other acceptable variations of flowcharts exist that are essentially equivalent to the methods explained herein. Furthermore, the flowcharts focus on the relevant topics of interest of the present invention, and therefore do not describe all requirements of a practical system for purposes of illustration.

FIG. 19 shows a flow chart for an optional embodiment of a multi-coin system, or a completely overlapped mixed denomination, coin multiplier method. In this case, the wager level is considered only, and the number of required virtual pools equals the number of possible wager levels of the system, where wager level is associated with wager value.

FIG. 19B shows a flow chart for an optional embodiment of a multi-denomination method. The key difference from FIG. 19 is that the multi-denomination method considers only the denomination of the wager. Note that other portions of the flow chart are not shown in the optional case of a max coin requirement for hitting the progressive jackpot as discussed previously.

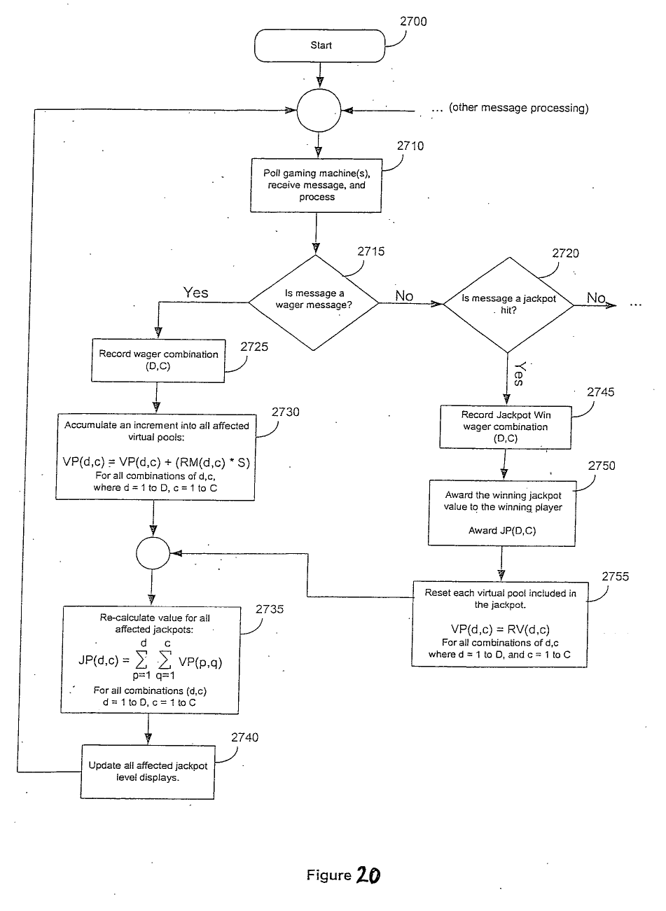

FIG. 20 shows an optional embodiment of a partially overlapped mixed system flowchart. In this case, both the coin multiplier and the denomination of the wager are considered, and the resulting contributions are grouped in a partially overlapped manner as discussed.

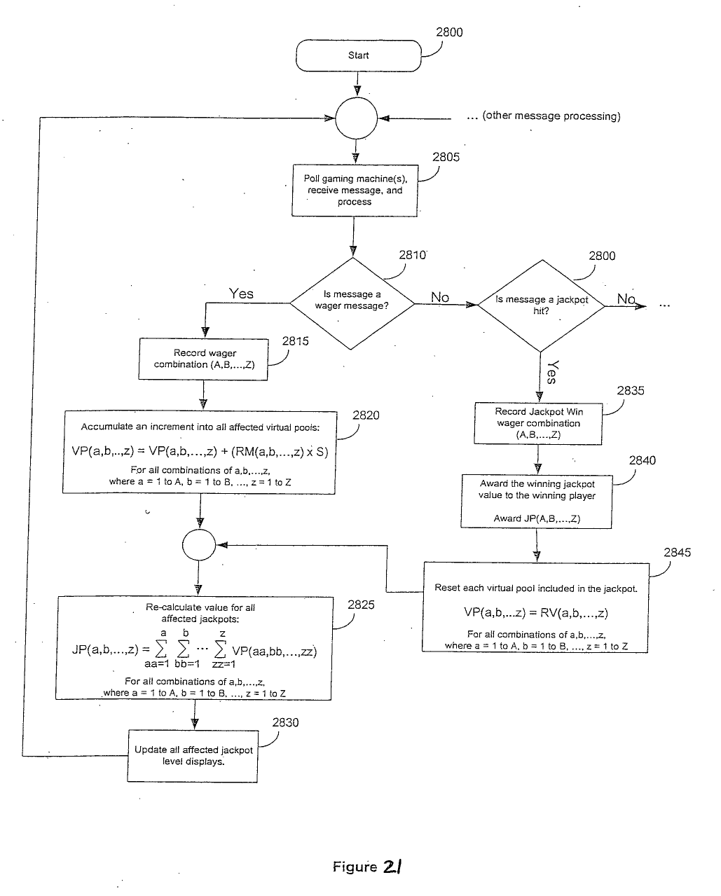

FIG. 21 shows an optional embodiment of a multi-axis progressive system flowchart, where more than two aspects of the wager are considered. For example, a third attribute may be associated with the wager, for example, the level of standing in a player club. In this case, consider a casino has a player club, where each player gains a percentage “favor” in return for being a good customer. The club may offer four levels of rating, a bronze rating, a silver rating, a gold rating, and a platinum rating. Each rating may be represented by a rate scale as previously introduced for coin multiplier and denomination. For example, perhaps the bronze player is entitled to a 25% proportional rake of the jackpot return. The silver club member is entitled to 50%, a gold player to 75%, and a platinum player entitled to 100% proportional jackpot return. Therefore, three axis exist in the example rate multiplier table, and the matrix of virtual pools may be considered as a three dimensional block of virtual pools. The awards could be partially overlapped as in prior examples of mixed, partially overlapping methods. The process would continue as in flow chart of FIG. 21, with three indexes, one for coin multiplier, one for denomination, and one for player rating. In this manner, the casino can entice playes to become better customers, and hence gain better standing in the players club. The method does so in a fair and consistent manner. The method allows the casino to customize the rate of progressive increment and the rate of progressive eligibility into each pool, by scaling relative worth to each attribute of the players wager. For example, higher wager rating is equivalent to a higher percentage contribution which is equivalent to money returned to that rating of player. In all three axis, rate multiplier scales can create advantages to players with better rated wagers.

The progressive system can determine the rating of the player by scanning the associated player card inserted by each player. If a player does not have a player card, that player may represent a 0% take of the progressive prize as an example, and therefore not be eligible for progressive prizes.

It is expressly contemplated that the paypack percentage of the gaming machine may be used as an additional attribute when considering the overall rank of a wager in one option of the present invention. In this optional embodiment, a series of rate multipliers are introduced as another independent axis into a mutli-axis rate multiplier system as described above. The system of this option allows machines of different payback percentage be linked together into a single progressive link and progressive pool. By adjusting the series of the rate multipliers, each rate multiplier associated with a specific game payback percentage, the average progressive award each game pays back, over time, can be adjusted to be equivalent. In this manner, players play for different sized progressive jackpots, all funded by the same progressive pool, and whose size is influenced by the particular payback percentage of the underlying primary game in a manner consistent with the present invention.

FIG. 6 illustrates an internal representation of the controller 1050 of the present invention given the circumstances of the example. It should be noted that FIG. 6 is illustrative of the functional method. It is expressly noted that the method of the present invention is not limited by the example used, but can be extended to any combination of denominations, for example. Furthermore, such methods are typically implemented in software, but the present invention is not limited to purely software implementations. FIG. 6 also shows a communications process 1630 in block form. Again, the details of the communications process could take many different forms depending on the specific hardware implementation chosen. Examples of hardware communication choices could include 1) UART generated communications, and 2) Ethernet based communications. The block diagram 1630 does not illustrate such details of the communications interface, nor does it detail other underlying software required to interpret and process such communications. Only specific features of the present invention are described and included to aid in describing novel aspects of its operation.

A series of progressive rate multipliers 1620 is shown. These progressive multipliers are intended to scale the value of a unit bet, such unit bet originating from a specific source as shown by the arrows and lines connecting specific events to specific rate multipliers. Therefore, the optional progressive rate multiplier 1620 shown accepts a single argument as its input. The presence of multiple inputs leading to some progressive multipliers 1620 is used to illustrate possible information flow in the controller. The output of the rate multiplier is a fixed monetary amount, which is a percentage of a single unit bet. For example, if the unit bet is 5 cents, and the rate multiplier is 1%, then the fixed contribution that is added to the virtual pool is 0.05 cents.

While FIG. 6 describes one possible method for tracking progressive contributions for wagers of different denominations, it should be noted that other equivalent and alternate optional approaches for tracking this information exist. For example, instead of tracking and tallying contributions to virtual pools, it is possible to track the number of occurrences of different denomination wagers, for example. Using this form of representation, it is possible to duplicate the functionality of the controller. Therefore, the present invention is not limited to the use of virtual pools 1600, since other equivalent forms of tracking wager information are possible.

Furthermore, the rate multipliers 1620 need not be multipliers at all. For example, in one optional embodiment the output of the rate multipliers 1620 are always the same value. The reason is that the unit bet information in this example is a fixed value, and the rate multiplier is usually fixed in value, although this is not a limitation of the present invention. Therefore, instead of showing a progressive rate multiplier, a fixed value may be stored and then added to the virtual pools for every unit bet processed. However, the invention is not limited to using rate multipliers. In fact, an optional embodiment would pre-calculate the output of each rate multiplier and store that value so that the multiplication process is not repeated in a redundant fashion.

Description of Typical Apparatus of Invention

Progressive Display Operation

Progressive systems usually require a means for displaying the progressive jackpot. There are several general types of displays, for example, an overhead display, an in-machine display, or an on-screen display.

The methods of the present invention allow for games of multiple wager sizes and wager denominations to be linked to a single jackpot pool. However, in so doing, a plurality of jackpot “sub-levels”, or wager levels, is created. Therefore, in an optional embodiment, displays are used to help the player understand the progressive jackpot offering, and how the wager level influences the amount of money he or she is playing for.

Several example methods for displaying the progressive jackpots of the invention have been previously introduced. One such method displays the entire jackpot prize pool in combination with individual jackpot awards for each level of wagering. However, in some cases, displaying all possible levels of progressive jackpot for each level or combination of wagering is not practical.

As a method of the present invention, an optional display embodiment is contemplated which alters the display of the progressive value in response to the wager level, or wager combination, made by the player. For example, if a player wagers a single nickel, as in a prior example, the in-machine display located with the player will show the progressive jackpot associated with a single nickel bet. If that player wagers another nickel, the in-machine display immediately displays the progressive value associated with a two nickel wager, and so on. Therefore, the display, or plurality of displays, associated to each player, dynamically alter in response to the player's wager level(s), or wager combination(s). Generally, the display can show $0.00 if there are no coins bet, or in another option, show the entire jackpot pool, which would represent the maximum value that could be awarded by the progressive system.

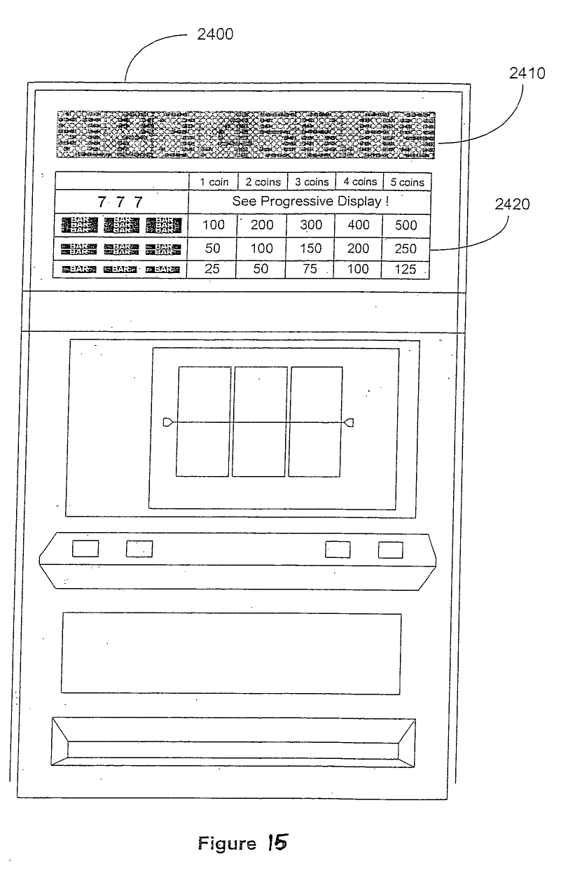

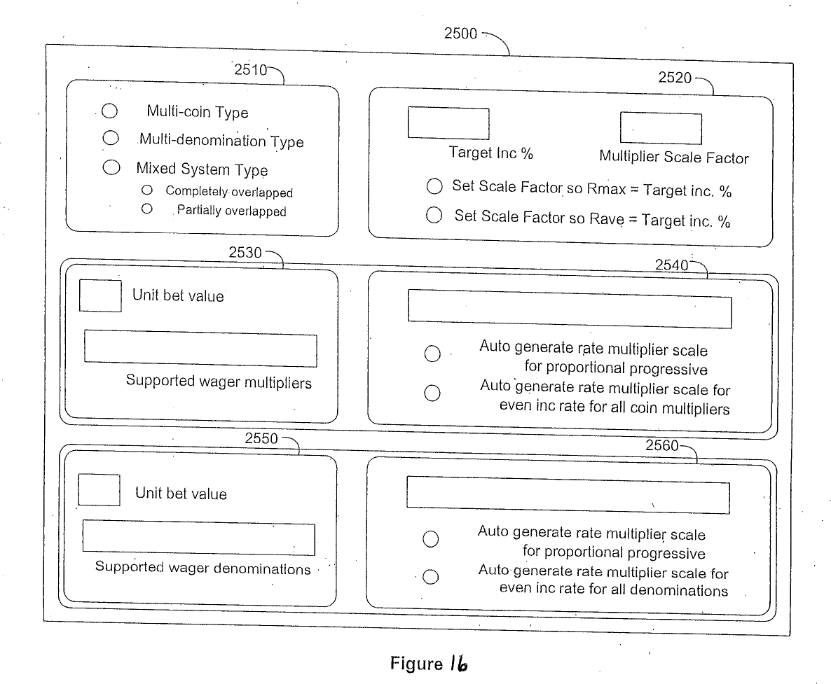

In FIG. 15, an example gaming device 2400 is shown. This gaming device shows in-machine display 2410 mounted in the gaming device “top box”. In one option, the in-machine display 2410 may be an LED type display, or other type display, such as LCD display. An example paytable 2420 is also shown. Paytables 2420 are commonly displayed on gaming devices, and are well known in the art. In the prior art, it is normal that the progressive jackpot be paid to max coin players only. In this case, a single in-machine display 2410 can display the jackpot continuously.

In the method of the present invention, the in-machine display 2410 changes the value of the display in accordance with the wager made at the gaming machine. It should be noted that players may wager in an incremental fashion, such a placing a single coin at a time, or pressing the “bet 1” button. In response to each wager level made, the display will show the associated jackpot amount that the player is playing for.

In the optional embodiment of FIG. 15 and paytable 2420, the top level award is three sevens, i.e., 777. The top level award is associated with the progressive jackpot as seen by the phrase “progressive jackpot” replacing all levels of coin wager, which is 5 coins in the example machine of FIG. 15. In this case, the in-machine display is responsible for showing the progressive jackpot associated with each level of wager in response to each level of wager being made.

In one option of the invention, the display supports higher resolution, and displays all possible levels of progressive jackpots at once.

Alternatively, the in-machine display 2410 can rotate the display of each level of progressive jackpot. For example, before wagering has begun, the progressive jackpot associated to a single coin wager is shown, then the progressive jackpot associated with a two-coin wager is shown, and so on. Once wagering has begin, the display begins to show the value associated to the current level of wagering.

It should be noted that paytable 2420 may optionally be displayed on a video screen, such as a video poker gaming device. In this case, each level of progressive jackpot can be displayed at once. For example, on paytable 2420, at the row represented by the 777 jackpot payline, and column represented by a one coin wager, would be the current value of the progressive jackpot associated with a single coin wager.

In FIG. 14, an example video display 2300 of a video based three-reel slot machine is shown. In this figure, the three-reel slot supports five paylines. Multiple paylines allow the player to place multiple wagers, a wager for each payline. The video game of the example allows a different wager level for each payline. For example, the gaming device supports a coin wager meter 2345 for the center payline, and it shows a wager of 5 coins for center payline. The game also supports a progressive jackpot display 2340 associated to the wager level of the center payline. The progressive jackpot display 2340 shows the progressive jackpot for the 5 coin wager is $263.54. In like manner, each coin wager level meter has an associated progressive jackpot level meter, ex., meter 2305 in FIG. 14. If the level of coin wagering is the same for two or more paylines, the associated progressive value will be the same, i.e., such as progressive value display 2305 for diagonal payline and the progressive display 2320 for the top payline shows in FIG. 14 by means of example.

Terminal Contribution Rate

Another optional feature, the terminal contribution rate, is introduced by the methods of the present invention. It is generally important that a progressive prize pool ultimately terminate; that is, that the jackpot value be ultimately awarded in its entirety. In the methods of the present invention, we have also introduced the notion of maximum sized wager. In the methods outlined, the maximum sized wager is associated to the largest jackpot, which is usually a summation of all virtual pools associated to the jackpot. However, in some cases, the true maximum size wager may be too large, or represent a wager value that may seldom be awarded the progressive jackpot in practice. In this case, a practical value for the maximum sized wager is made. Therefore, wagers greater than the “maximum sized wager” may exist. In this case, the difference of the value of the wager from the maximum wager limit can contribute to the largest virtual pool.

Therefore, the maximum sized wager is now treated as a terminal contribution value, i.e., a defined wager level or value for which no additional virtual pools are managed. (alternatively, an additional virtual “overflow pool” can be managed, and even given a separate rate multiplier, but the difference is little more than semantics). Therefore, if a player wagers at the maximum wager limit or beyond it, and hits the progressive jackpot, the player is awarded the highest progressive jackpot award regardless of the amount of wager in excess of max wager level. Therefore, this option allows the method of the present invention to support wagers with unlimited value, while still offering a progressive prize for such wagers.

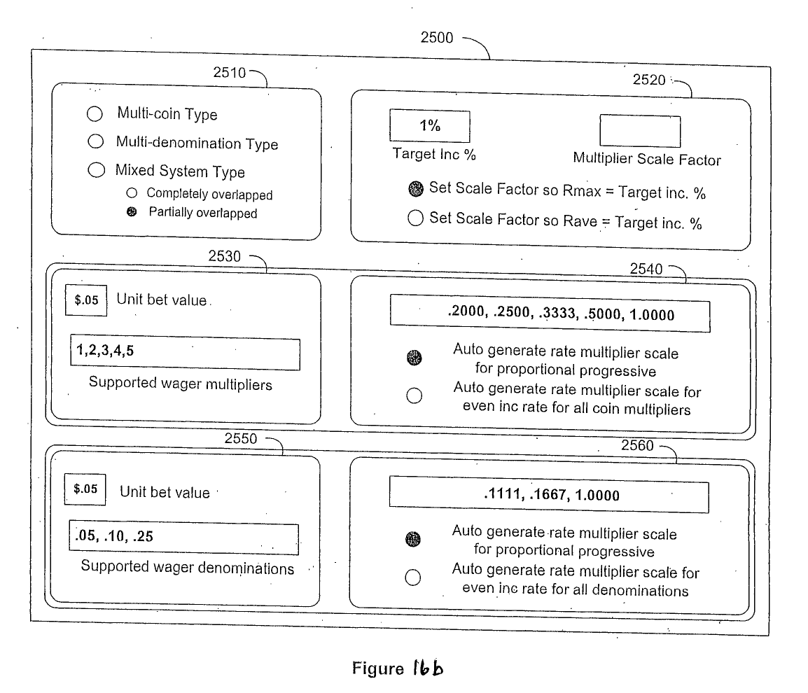

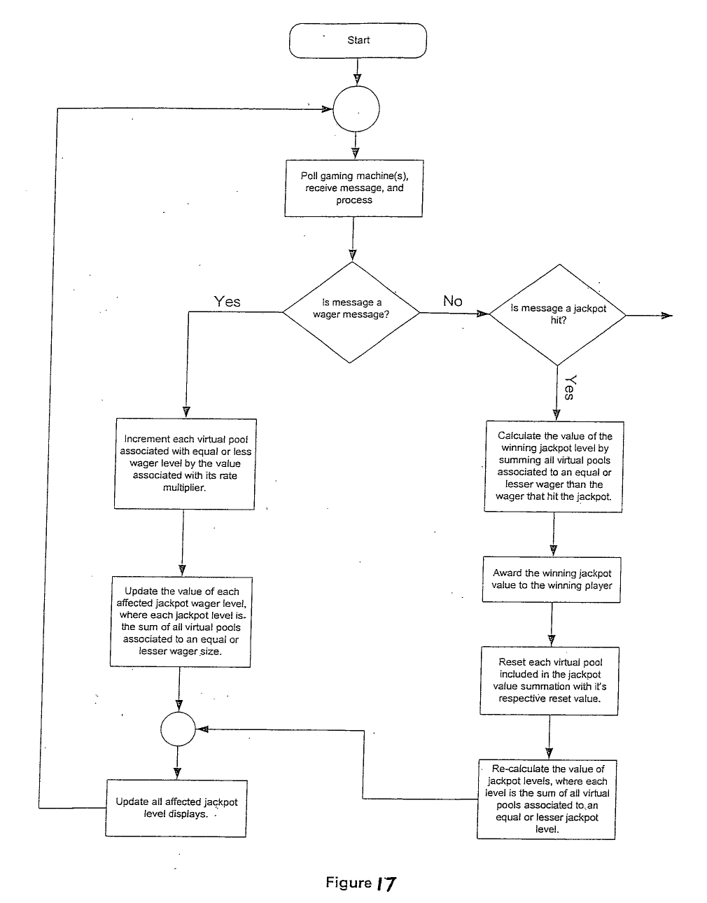

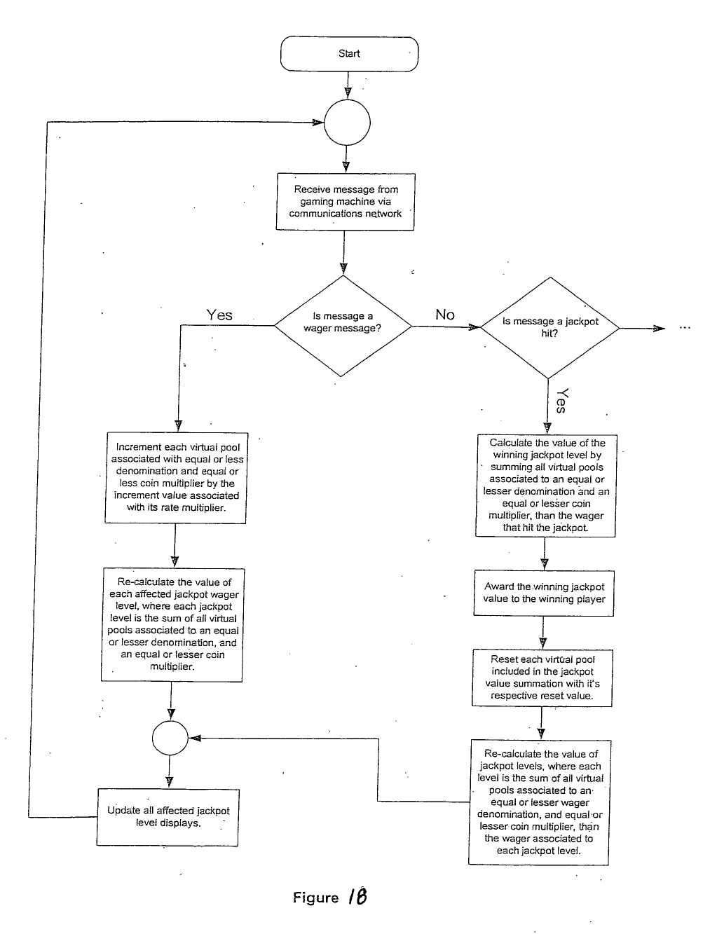

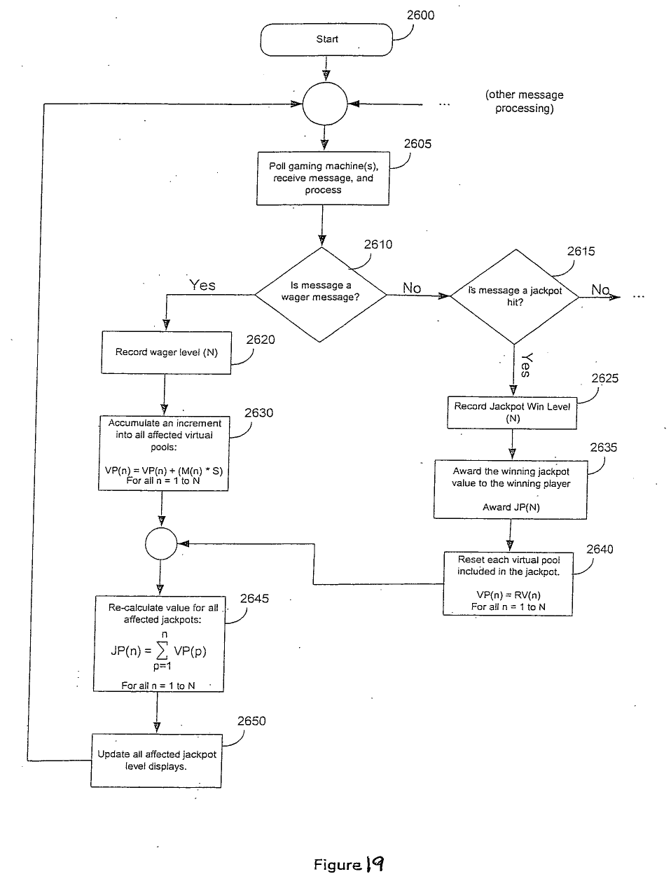

Overview of Invention To review, one optional form of the methods of the present invention is given with some of the optional configurations and set-up screens that a user might employ to configure the progressive system of the present invention. Consider FIG. 16 which depicts an example user set-up screen pertaining to some aspects of the present invention. It should be noted that FIG. 16 is an example, and does not demonstrate all aspects, options and applications of the present invention. It is understood by those practiced in the art that a plurality of set-up screens are generally required in practice, and that such arrangement of screens are particular of the embodiment, features and options offered by the particular progressive system.

In FIG. 16, a menu driven set-up screen is shown for the controller of the present invention. A dialog box 2510 is shown which shows a bullet menu. A bullet menu is commonly known to those skilled in the art; the bullet menu allows the user to select one of the main bulleted options. If the bullet adjacent to the Mixed System Type is selected, an additional sub-bullet menu is activated, allowing the user to select between different types of mixed system, i.e., a completely overlapped, or partially overlapped system, in this case.

Dialog box 2520 allows the user to enter a target increment rate into a text box. A bullet menu selects between two choices, one choice allows the controller to set the overall scale factor S such that Rmax is equal to the target percentage, the other choice allows the controller to set the overall scale factor S such that the average increment rate (of a proportional system) is set equal to the average increment rate. Dialog box 2520 may also allow manual entry of the multiplier scale factor, for example, if no bullet options are selected. Dialog box 2520 could also be more complex, offering advanced features that allow more advanced set-up of rate multipliers, for example. It could also offer more bullet choices for set-up of coin-multiplier rate multiplier scale, for example.

Dialog box 2530 of FIG. 16 allows the user to enter the maximum number of coin multipliers supported in the link. If coin multipliers are entered, the system will configure the link to use coin multiplier information in determining the rank of the wager, and will automatically generate the rate mutliplier scale for coin multipliers, for example. A text value is provided by the system to indicate the unit bet value, which can be automatically selected by the system in response to the most efficient choice based upon the coin multiplier list, or manually entered otherwise. In dialog 2540, the rate multipliers for coin multipliers are listed. These values may be automatically generated by the configuration system if any of the bullet options of dialog box 2540 are selected, for example. Otherwise, manual entry of rate multiplier values can be made.

Dialog box 2550 of FIG. 16 allows the user to enter all valid coin denominations into the system. If all possible denominations are entered, the system can configure the link to use wager denomination information in determining the rank of the wager, and will automatically generate the rate multiplier scale for wager denomintations, for example. A text value is provided by the dialog box to indicate the unit bet value, which can be automatically selected by the system as the most efficient choice based upon the coin multiplier list and coin denomination list, or manually entered otherwise. Error messages can warn users if illegal, or improperly matched data is being entered. In dialog box 2560, the values for the rate multipliers are listed, and can be automatically generated in response to choosing an appropriate bullet menu below. Otherwise, rate multiplier information can be manually entered.

FIG. 16B shows the same set-up menu of FIG. 16 with the values representative of the example used for partially overlapping mixed progressive method.

Once the appropriate set-up information is entered into the configuration and set-up utility, the information can be transmitted and stored into the controller 1050 of the present invention using system communications or other optional connection, such as an RS-232 port for example. In FIG. 5, and by means of example, the controller 1050 of the present invention supports a Configuration and Control Unit 2290 function. This function is shown as an independent block for purposes of illustration, but the present invention is not limited to such separation. In one option, the Configuration and Control Unit 2290 is additional logic implemented via software or firmware, its function to coordinate the set-up, initialization and control of the progressive controller and its internal memory and data arrays. The Configuration and Control Unit 2290 coordinates the progressive controller set-up and initialization tasks with that of the Configuration and Control Utility, such as the Configuration Set-up computer 802 of FIG. 6. It should be noted that the configuration and set-up utility need not be an external device, and may exist as a component of the controller itself, for example, via an integrated LCD screen or LED display. The configuration of the controller may also be performed by other means, facilitated by a configuration file for example, or via hard coded memory within the controller 1050 in another option.

Variations and/or Other Bonus Game Inventions:

The methods of the present invention are not limited to standard casino game applications, i.e., slot machines and video poker machines. The methods of the present invention can be applied to internet gaming, for example. Any internet-based gaming device can offer a progressive jackpot, in which the jackpot pool is divided according to the methods of the invention, thereby introducing jackpot awards that are scaled according to wager buy-in, where such pools either overlap, or partially overlap.

A standard gaming machine, a tournament game, or any game of chance can employ the principles as set forth. Furthermore, the methods of the present invention can exist as sub-components in many types of game concepts and bonus game ideas. Some examples are explained next.

Mystery Jackpot with Proportional Jackpots

In the prior art, progressive link type bonus systems exist. One such system is the so-called “Mystery jackpot”. The mystery jackpot is essentially a progressive link wherein the progressive controller itself determines the winner, by random choice.

In the prior art, a Mystery jackpot system has certain advantages over a standard progressive jackpot of the prior art. One such advantage is the ease in mixing multi-denomination games to mystery jackpot links. The reason is the mystery jackpot can be scaled to use a unit bet, where each wager is divided by the unit bet to determine how many opportunities are allowed at hitting the random event, which is the “mystery jackpot”. Therefore, and by means of example, a player wagering a nickel may have a single opportunity at the mystery jackpot, whereas a player wagering a quarter will have 5 such opportunities.

For example, one prior art method uses a secret value. When the progressive pool reaches the secret value, the mystery jackpot is awarded to the player causing the pool to equal or exceed the secret value. The secret value is then awarded to that player. The pool increments a fixed percentage of each wager placed. Therefore, the larger the wager, the higher the pool increases. Therefore, larger wager sizes have a proportionally higher number of opportunities to hit the secret value, and hence hit the mystery jackpot.

One potential pitfall of the prior art mystery jackpot occurs when the jackpot is hit. In this case, the award resets to the base value, and the bonus incentive is immediately and fully reduced. Another potential problem is that players wagering at each level of denomination, or coin multiplier, or level, are not isolated to any degree. In other words, a single jackpot is offered to all regardless of wager level.

The methods of the present invention can be combined into a mystery jackpot system to provide a more dynamic approach to offering awards, whereas such awards are sub-divided, and each associated to a specific level and/or combination of wagering. The awards are either partially or completely overlapped. However, because the system is a mystery jackpot, the controller of the present invention will determine the winner of each jackpot award.

For example, consider an optional embodiment of a mystery jackpot employing the methods of the present invention. A secret jackpot value SJ is determined randomly from a range of values between a low limit and a high limit. A current jackpot pool JP is started at some base level, or at zero. The jackpot pool may be sub-divided by the methods of the present invention according to multi-coin, multi-denomination, or other attributes, or some combination of these attributes. Therefore, a plurality of virtual pools may be used to track relative contributions of each wager combination in a fair a consistent manner. An associated plurality of jackpot pools, or jackpot awards, is created by summing the respective virtual pools per the methods disclosed. In other words, the mystery jackpot according to this optional embodiment now has a plurality of award levels, each award level associated to a specific level, or combination, of wager. For example, a nickel player would only receive a chance at hitting the award associated with the nickel mystery jackpot. The quarter player would receive a chance at hitting the award associated to the quarter mystery jackpot. The two jackpots may be completely overlapped, for example, so that if the quarter player hits the mystery, the award includes the complete value of the nickel mystery award. Otherwise, the jackpots may be partially overlapped, in some other manner as previously described.

However, as with the methods for standard progressives, a total jackpot pool could be defined, as the sum of all virtual pools. In the case of the mystery jackpot, the controller tracks the value of the overall jackpot pool (which is associated with the highest wager possible in one option) and continually compares this value with the secret jackpot value SJ. The player whose wager increases the value of the overall jackpot to meet or exceed the secret value SJ wins the jackpot. The value that the player wins could be determined by the method of the present invention, in accordance to the specific summation of virtual pools their respective wager entitles them. The mystery jackpot could reset in accordance to the principles set forth, i.e., each virtual pool included in the jackpot summation is reset to its associated base value.

Therefore, in many cases, the mystery jackpot of the present invention will not always reset to its minimum starting point (i.e., the starting point, or base value, of prior mystery jackpots, for example). For example, consider a nickel wager mystery jackpot is $100, and a quarter wager mystery jackpot is $500, both being shared jackpots of the mystery of the present invention. For purposes of simplification, assume a zero reset value. Therefore, if a nickel player hits the mystery, the mystery would reset to $400, and therefore the jackpot is not completely reset. However, if the quarter wager is the maximum wager size, and entitled to the summation of all virtual pools, a quarter mystery winner will receive all $500 of the jackpot pool.

In an optional embodiment, the mystery jackpot of the present invention could reset jackpots in a new and novel manner from the prior art. For example, if a nickel player wins only a portion of the overall jackpot pool, then upon mystery jackpot reset, a new secret value could be determined between the range of the new value of the (overall) jackpot pool, and a new high value, which can be determined as a high limit added to the current jackpot value. In another option, a new secret value could be determined between the new present value of the jackpot and the same fixed high value as programmed into the controller during set-up. In most prior art systems, once a jackpot is awarded, the standard mystery jackpot resets, and the controller selects a new secret value using a pre-programmed fixed low limit and fixed high limit; the reason is the prior art mystery jackpot pool is awarded in its entirety, and therefore resets to the same value.

Another difference with an optional embodiment of a mystery jackpot of the present invention is the manner in which wagers are processed. In the prior art, the wager size affects the number of opportunities the player receives at hitting the mystery jackpot. With a mystery jackpot method according to an optional embodiment of the present invention, this is no longer necessary. For each wager, every player can optionally receive a single opportunity at being selected by the controller to win the mystery jackpot. In this case, the embodiment for determining the mystery jackpot may need to be different than the prior art as well. However, this is not a limitation of the method. This fact allows more flexibility with mystery jackpots that are configured to pay very frequently, for example. In this case, all players, regardless of wager value, can hit mystery jackpots at a frequency consistent with the rate at which underlying games are being played, and not so heavily dependant on the relative size of the wager.

Therefore, the methods of the present invention can be used to create a mystery jackpot system that offers awards that are graduated and grow increasingly larger when larger, or greater valued wagers, are placed. The new mystery jackpot system creates incentive to increase wager size since larger jackpots will tend to accumulate with pools associated to larger wagers. However, using the aforementioned rate multipliers, and adjusting such rate multipliers accordingly, different relative rates of mystery jackpot award growth can be created for each denomination, level or combination of wager. Furthermore, levels of isolation can be created between players wagering different coins, denominations, or combinations of wagers. This isolation can be used to provide incentive to place larger valued wagers. The level of isolation also addresses the problem with mystery jackpots, since not all mystery jackpots cause the entire pool to reset to its initial starting state. In particular, players placing larger valued wagers are entitled to jackpots whose value is partially protected from players placing lower valued wagers.

Application to Casino Table Games

The methods of the present invention could be adapted to casino table games, such as Blackjack, Craps, and other table based progressive games found in the “pit” of a casino.

One significant limitation of prior art progressive systems when applied to tables games, such as blackjack, is the ability to scale the award in proportion to the wager made. In such games, the range of wager values can be large, and therefore, players wagering high stakes may not be interested in progressives that cover lower stakes, for example. Since table games tailor to specific wager sizes and ranges, such as a $5.00 minimum table versus a $100 minimum table, it makes sense to offer separate awards to each wager level. Since even a $5.00 minimum table will accept a larger wager of $100, it makes sense to provide a system that links all wager sizes, and offers incentives to players to place larger wagers.

Prior Art Progressive Table Games

In one prior art case, a progressive jackpot is offered on the game of Blackjack. In this case, a separate side wager is used to fund the progressive jackpot. The progressive table game allows the player to place a side wager of a single dollar to be eligible for a progressive jackpot for each round of play. In a typical situation, approximately 70% of each dollar side bet is used to fund the progressive jackpot; the remaining 30% goes to the house. The player wins the progressive jackpot when he or she draws a “lowball” straight flush (i.e., a suited ace, deuce, three, four and five) during the course of drawing cards (“hitting”) to satisfy the game of twenty-one (without busting), although, any arrangement or sequence of cards could be defined as a winning outcome.

The apparatus of the prior art progressive table game tracks and monitors several aspects of the progressive table game. For one, the apparatus counts each progressive side bet made and tallies the progressive pool using a pre-programmed, flat increment rate. The apparatus tracks each fixed side wager by using a coin slot or specially marked area on the table supporting apparatus capable of detecting the presence of the side bet. The progressive table system also “locks in” each side bet before the dealer initiates the round of play, or deals any cards. The lock in feature is typically supported using a so-called “lock-out” button. Once the dealer pushes this button, only those players that have placed a progressive side wager will be eligible for the progressive game for that round. Any player not having placed a progressive side wager will be “locked-out” of the progressive game during the course of that round of play. The apparatus of the prior art table game typically supports an indicator light at each player position, which lights in accordance to whether the player is eligible for the progressive jackpot via having placed the progressive side bet prior to game play (i.e., prior to lock-out).

There are other optional embodiments of the prior progressive table game, but most support a scheme very similar to that just explained. For example, some prior art progressive table games support alternate primary games, as opposed to the game of twenty-one. Others support several levels of progressive jackpots, or multiple progressive “groups” as defined earlier. In such a case, several winning game outcomes are recognized that pay different amounts, and hence more than one progressive jackpot pool is supported, one associated to each specific winning outcome.

The problems of prior art progressive table games are many. One problem is the fact that the progressive wager is an independent side bet, and neither influenced nor affected by, the wager made for the primary game (i.e. the game of blackjack in this example). Therefore, in the case of prior art table progressive systems, the progressive game is funded independently from the primary game, and therefore cannot provide any incentive to players to alter their primary game wagers. Another problem with the prior art table progressive system is the fact that the progressive side wager is fixed. For example, for players wagering say $5 per hand, the additional side bet of one dollar may be a significant cost. On the other hand, for players wagering $100 per hand, the cost of the progressive side bet may be negligible. Therefore, the progressive feature may only appeal to a certain range of players making a certain range of wagers. Also problematic is the fact that prior art progressive table games only support a single jackpot award funded from a single jackpot pool (not to be confused with offering only a single progressive group). The single jackpot value does not scale readily to players making wide ranges of betting, nor does it entice players to alter their wager size, for example, in response to changes in the progressive jackpot prize offered.

New Method of Present Invention for Progressive Table Games

The method of the present invention for table based progressive games supports one or more progressive jackpot “sub-levels” as presented in prior sections for multi-coin and multi-denomination progressives of the present invention. That is, the method supports one or more virtual pools in which players making various levels of wager “buy-in” become eligible to win a progressive jackpot prize that is the sum of an associated range of such virtual pools. This effectively allows a player to select the progressive jackpot the player will be awarded if the player fulfils the progressive jackpot conditions. Thus, for example, in a card game if the player wins the progressive jackpot by receiving the correct winning combination of cards, that player is awarded the sum of the virtual pools that were bought in, in a manner analogous to that presented for multi-coin and multi-denomination progressives as discussed earlier. In this manner, progressive jackpots for table games are sub-divided into distinct jackpot sub-levels funded from a single overall progressive pool. This overall progressive pool is formed by contributions of all players wagering on the progressive link regardless of wager size. As discussed earlier, the overall progressive pool represents a single pay-level of the game, and is associated to a specific winning outcome and probability. As in earlier discussions, the concepts presented here can be extended to support multiple jackpot pools or multiple progressive groups as defined earlier (i.e., multiple progressive pools, one associated to each of the supported winning outcome pay levels).

The method of the present invention as applied to table based progressive games provides a manner in which progressive contributions are funded. According to an optional embodiment of the present invention, the progressive contribution is influenced by the size of the wager made on the primary game. In one option, the progressive pools are funded by a separate side wager that is independent of, but also proportional to, or a percentage of, the primary game wager. In another option, the progressive is funded by a percentage take of the primary game wager itself, as is typical for electronic gaming devices, such as slots and video based gaming devices. The main difference between these two options is that in the first option, the player can elect to place the side bet to “buy” eligibility into the progressive game. In the second option, the player can be eligible for the progressive game as a result of playing the primary game itself, i.e. the player is always eligible for the progressive jackpot for each wager placed on the primary game.

Regardless of the manner in which the progressive contribution from each wager is funded, be it a portion of the primary game wager, or a portion or all of an optional side bet, in an optional embodiment, its value is influenced by the value of the primary game wager. The method by which the progressive contribution from each wager is influenced by the primary game wager is in accordance with the principles set forth for multi-coin and multi-denomination progressives set forth earlier. In particular, using the methods set forth earlier, the progressive contribution amount is a percentage of the primary game wager; but this percentage may vary depending on the primary wager size, since rate multipliers for each virtual pool may be different. This is explained in greater detail next.

In the method for table game progressives of the present invention, the concept of a unit bet is used. That is, an incremental value of wager is defined. The most efficient choice for the unit bet is the Greatest Common Divisor (GCD) of all wager values supported by the primary game. For example, in some casinos, a typical minimum sized wager is $5 per hand (in the game of twenty-one for example). The player may elect to increase their wager in increments of $5 since a $5 dollar token, or gaming chip, is used on the table game. Therefore, in this case, an efficient choice for the unit bet is $5.

Typically, other commonly used denominations of gaming chips are also in use on the table game, such as a $25 chip and a $100 dollar chip. Other denominations of gaming chips are also possible, as the present invention is not limited to the types and number of denominations of gaming chips used. Note, however, that the player may place wagers in increments of $5 in this case, and that there may be a minimum wager size, such as $5 in this example, and optionally, a maximum sized wager that is allowed for each hand of the primary game.

In one method of the present invention, a plurality of virtual pools is managed, one pool for every incremental unit bet of wager possible for the primary game. For example, if the table game minimum wager is $5, and the table maximum is $100, there may be twenty such virtual pools managed, one pool for each unit bet wagered, where one pool is associated to each of twenty levels of wager. For each unit bet wagered, a progressive increment rate is defined. Each virtual pool will therefore track and tally a progressive contribution from each unit bet of each wager in a manner consistent to that described for multi-coin progressives. For example, if a player makes a $5 wager, then a progressive contribution is accumulated to only the first virtual pool, VP1. The value of this contribution is the value of a single unit bet times the progressive increment associated with the first virtual pool, M1. If a player makes a $10 wager, then a contribution is accumulated to the first and second virtual pools, VP1 and VP2. Specifically, the first virtual pool VP1 will tally a contribution equivalent to a single unit bet times the progressive increment associated to the first virtual pool, M1. The second virtual pool, VP2, will tally a progressive contribution equivalent to a single unit bet times the progressive increment rate for the second virtual pool, M2. In a similar manner, each unit bet of each wager will cause its associated virtual pool to tally a progressive contribution equal to a single unit bet times its associated progressive rate multiplier. In other words, for each unit bet (n) of each wager, a progressive contribution is tallied into virtual pool VP(n) whose value is equal to a single unit bet times its associated rate multiplier M(n).

In the method of the present invention, a plurality of progressive jackpot awards is managed. Each progressive jackpot award represents that portion of the overall progressive jackpot pool to be offered for each level of wager. Therefore, each progressive jackpot prize is some portion of the overall progressive prize pool managed by the progressive system of the present invention. The overall progressive prize pool is the sum of all virtual pools managed by the progressive system, and is awarded to the winning player who places a maximum size wager, assuming the player has met any eligibility requirements, such as an optional side bet wager, if required. For example, if a player wagering only a single unit wager, a $5 chip in the example, wins the progressive jackpot, then that player will be awarded the value contained within virtual pool VP1. If a player wagering two unit wagers, $10 in the example, wins the progressive jackpot, then that player will be awarded the sum of the values contained within virtual pools VP1 and VP2. In a similar manner, if a player wagers (n) unit bets on the primary game (in total value) and wins the progressive jackpot, then the player will be awarded the sum of all virtual pools VP1 through VP(n).

Once a progressive jackpot is awarded, a progressive jackpot reset process may take place. The reset process accounts for the fact that a portion, or all, of the progressive jackpot pool has been awarded. The progressive reset process affects all virtual pools that were summed in the process of awarding the progressive jackpot. For example, if a player wagers only a single unit bet, then only virtual pool VP1 is awarded. Immediately after the progressive jackpot award process, a reset value, or base value, is restored back into virtual pool VP1. This reset value may optionally be zero, or optionally some other non-zero value. If a player places an (n) unit bet wager and wins the progressive jackpot, then virtual pools VP1 through VP(n) will reset. In the method of the present invention, a plurality of reset values, or base values, is managed. Each reset value RV(n) is associated to its respective virtual pool VP(n). Upon a jackpot reset process, all virtual pools VPn summed in the process of awarding a jackpot will reset to their respective reset value RVn.

It should be noted that, in an optional embodiment, not all of the available progressive jackpot pool is awarded when a player wins the progressive jackpot with a wager less than the maximum sized wager. In such an optional embodiment, only a portion of the progressive jackpot pool is awarded. Therefore, the progressive jackpot pool is seen to decrease by the value of the progressive jackpot award minus the total amount of money restored into all virtual pools during the jackpot reset process. In this manner, progressive jackpot prizes are tiered, and players quickly identify the fact that larger progressive jackpots are awarded when larger wagers are placed on the primary game. The method of the present invention is also fair, since each unit wagered on the primary game can be considered a “buy-in” to each virtual pool. If a player wins the progressive jackpot, he or she is entitled to a progressive jackpot award which corresponds to the level of progressive buy-in.

In the preceding example, one option is contemplated for progressive table games of the present invention. Another possible option treats each wager as a combination of 1) number of chips wagered, and 2) denomination of wager placed. This option is similar to the partially overlapped progressive method of the mixed multi-denomination and multi-coin method discussed earlier. In this optional embodiment, the combination of chip denomination and number of each denomination is considered by the progressive system. In a similar manner to the partially overlapped mixed system, a matrix of virtual pools is managed. Each virtual pool in the matrix receives a contribution based upon whether the denomination associated to the virtual pool is equal to or less than the denomination of the wager, and whether the number of the denomination associated to the virtual pool is equal to or less than the number of the denomination of the wager. Since denominations can be mixed in a table game application, in one option, more than one (rectangular) group of virtual pools may be affected depending on the number of separate denominations of the wager.

In another optional embodiment, the value of the wager and the player standing or rank are considered in calculating the progressive contribution, determining which virtual pool is contributed to, and determining which virtual pools will be summed to compute the corresponding jackpot award. This option is similar to the mixed method where player club standing is considered as an additional attribute of the wager placed.

Optional Embodiments of Table Based Progressive System of the Present Invention

One optional embodiment of the present invention requires no hardware. In this option, the progressive system is completely manual, meaning that a human being acting as a dealer can manage the entire progressive game manually.

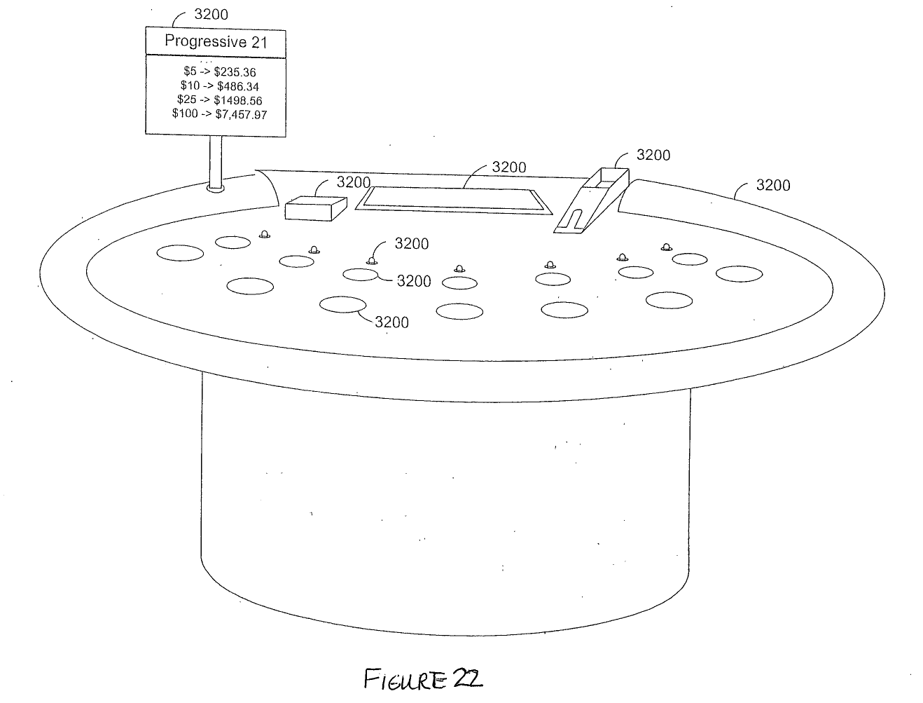

In another optional embodiment, a hardware and/or software based approach is used, as illustrated in FIG. 22. In this approach, hardware is used on the game table as well as optional computer systems acting as a progressive server interlinked with the table hardware using a communications network.

Several options are available for table based hardware mechanisms. A primary game betting area, or wager circle (i.e. betting circle), is provided for each player position. Optionally, a separate side wager area is provided on the table game surface for each player position on the table. A mechanism is provided beneath each primary wager circle and each side bet wager circle that detects the presence and value of the wager. For example, in the prior art, an RF-ID tag system is used. In such a system, each gaming chip has an embedded RF-ID tag containing a unique identification number and additional data identifying the rank and value of the gaming chip. Beneath each betting circle, an RF-ID tag antenna is located which connects to an RF-ID transceiver system. Using the RF-ID system, the presence and rank of each chip within each betting circle can be detected and identified.

In one option of the present invention supporting a separate side wager, at each player position, a progressive eligibility lamp is located. Before the start of the game, the eligibility lamp will light if the player has placed a progressive side wager that meets the value requirements determined by the system as a result of detecting the value of the primary game wager. For example, if the unit bet is chosen as $5, and a single $5 wager is placed on the primary game, and furthermore, the progressive contribution rate for the first unit bet is 1%, the eligibility lamp will light if at least 5 cents of value is detected at the side wager betting circle prior to the beginning of the round. In this case, the player is eligible for the progressive jackpot associated to a single unit bet of wager.

In this optional embodiment of the progressive system, a wager placed within the side bet wager circle may exceed the required value of the progressive contribution. Optionally, the system will tally only a portion of the wager placed in the side bet circle area, and track and store any remaining value that may be in excess of the required progressive contribution. If the player wishes to be eligible for the progressive jackpot in the next round, the system, by means of identifying the same gaming chip using the RF-ID tag system, will note that only a portion of the gaming chip within the side bet wager circle is available for use as a progressive contribution (that portion being the remaining value left from the prior round that deducted a progressive increment value). Thus, the progressive system is able to break the value of a single gaming denomination up into its specific progressive contributions automatically. This may be desirable, in an optional embodiment in which the value of the progressive increment deducted in each round of play may be only a predetermined or fixed fraction of the entire gaming chip placed in the side bet wager area. Such a system could, therefore, simplify the process of placing a wager, and deducting a fractional amount from that wager. Otherwise, fractional value gaming chips could be employed, and the player could be held responsible for placing the correct sized fractional side wager, however, most casinos prefer to use only standard gaming chips on gaming tables, and not slow the speed of the table game play due to complex side wager requirements.

In this manner, the progressive system is borrowing against the value of the side bet gaming chip, which remains within the side bet wager circle so long as the face value of the gaming chip is not exhausted. In other words, a gaming chip within the side bet wager circle could be treated as a miniature bank account. The progressive system borrows against the value of the gaming chip for as long as the miniature bank account has a balance remaining. When the value of the gaming chip within the side bet wager circle is exhausted, a signal is provided to the dealer to remove the gaming chip from the side bet wager circle. This signal may be in the form of a light at the side bet wager circle, or some other indicator at a display located at the dealer position. If the player elects not to be eligible for a progressive jackpot, the chip may be removed from the side wager betting area. In one option, the dealer cashes the chip in for the remaining value left as a result of fractional progressive contributions funded with the gaming chip. This remaining balance can be paid in cash, as a coupon, or even as a gaming chip with a customized value field written via the RF-ID tag system. If the remaining balance of the side bet gaming chip is non-zero, yet is not enough to satisfy the requirements of a future progressive contribution, the dealer may remove the gaming chip, and the system will track and retain the remaining balance of the side wager gaming chip. If the player wishes to continue to place a side wager, the remaining balance from the previous gaming chip can be added to the value of a new gaming chip placed by the player into the side bet wager circle. If the player wishes to cash out, the remaining balance can be refunded to the player as cash, coupon, or special gaming chip with the remaining value balance programmed into it.

In another optional embodiment of the table based progressive system of the present invention, the side bet wager circle is replaced by a side bet coin acceptor. Associated next to each side bet coin acceptor is a side bet credit meter. If a player deposits a coin into the side bet coin acceptor, the side bet credit meter registers, or tallies, the value of the coin accepted. For example, assume the side bet credit meter shows a zero value. If a player deposits a coin into the side bet coin acceptor, the side bet credit meter changes in response to the coin acceptor accepting the coin, and therefore displays the value of the coin deposited. In this option, the side bet credit meter replaces the gaming chip within a side bet wager circle. The system of this optional embodiment will fund contributions of the progressive jackpot by debiting, or deducting from, the side bet credit meter. As long as the value in the credit meter equals or exceeds the progressive contribution value required as a result of a wager being placed on the primary wager circle, the player will remain eligible for the progressive jackpot.

For example, assume a dollar is deposited into the side bet coin acceptor. The system accepts the dollar and registers a dollar value on the side bet credit meter. Next, assume the player wagers $5 on the primary betting circle before the round begins. In one option, the player has the ability to signal to the system that they would like to wager a side bet to become eligible for the progressive jackpot. In one option, this eligibility signal is in the form of a button. If the player pushes the button, and the system determines that there is enough credit value in the side wager credit meter to be eligible for the progressive, and an indicator lamp is lit to indicate to the player that he or she is eligible for the progressive jackpot in the current round about to commence. In another option, the mere presence of an adequate value in the side wager credit meter establishes the player's eligibility for the progressive jackpot, and the player's associated eligibility lamp automatically lights, i.e., the player is automatically enrolled into the progressive jackpot bonus feature. The difference between the two options is the choice given to the player to not wager a side bet even though the side bet credit meter shows a non-zero value.

In either case, the system detects the presence of the primary game wager, and by means of determining the value of the primary wager, computes the necessary progressive increment required using the methods of the present invention. The progressive increment is then debited from the credit meter upon the start of the round. The credit meter is seen to decrease as a result of the system debiting the side wager credit meter. In one option of the hardware embodiment, this debit occurs at the point of “lock-out”. In one option of the hardware embodiment, lock-out occurs when the dealer pushes the lock-out button immediately before dealing the cards of that round (or otherwise starting the game play for that round).

To continue this example, again assume the minimum wager is $5. Also assume the choice for the unit bet is also $5. Furthermore, the increment percentage for the first unit of the wager is pre-set within the system as 1% (M1=0.01). Thus, if the player wagers $5 on the primary wager circle, the system will debit a value of 5 cents (1% of $5) from the side wager credit meter, and add that 5 cents to the value of virtual pool VP1, i.e., the virtual pool tracking contributions from the first unit bet of the primary wager. The overall jackpot pool will increase by 5 cents. The progressive jackpot value associated to the $5 wager will be seen to increase by 5 cents. If the player wins the progressive jackpot, he or she will be entitled to the value contained in the virtual pool tracking the first unit bet, i.e., virtual pool VP1. If a player wagers $10 on the primary wager circle, and the system is pre-programmed to debit 1% for the first unit bet wagered, and 2% for the second unit bet wagered, a total of 15 cents will be debited from the side wager credit meter in response to the activation of the lock-out button. In this case, the value of virtual pool VP1 will increase by 5 cents, and the value of virtual pool VP2, which tracks contributions from the second unit bet of each wager, will increase by 10 cents. The total progressive jackpot pool is seen to increase by a total of 15 cents. If the player making the $10 wager wins the progressive jackpot, the player is awarded a value that is the sum of virtual pools VP1 and VP2.

These examples assume there is a zero rake by the house from the side wager credit meter. In one option of the system, the house (i.e. casino) benefits directly from any and all side wagers placed. In this case, a “rake” can be established in terms of a fixed percentage of the progressive contribution required from the side wager credit meter in response to determining the value of the primary wager, in accordance to the method set forth herein. In this case, the rake will deplete by an even percentage all values tallied by all virtual pools in response to a progressive side wager being made. In another option, a fixed percentage of the total amount of the required progressive contribution for each primary wager can be made in addition to the amount determined by the system. In another option of the present invention, a fixed cost can be established and granted to the house for any sized side wager made for eligibility into the progressive jackpot bonus feature.

In both hardware embodiments for a side bet wager detection apparatus, according to the optional embodiment described above, a fractional portion of a unit bet may be required to fund the progressive jackpot in accordance to the value determined by the system, which is influenced and determined by the value of the wager of the primary wager circle, in accordance to the methods of the present invention. Specifically, the cost, or debit value from the side wager credit meter, will be a value determined by the number of unit bets represented by the value of the primary wager, and the percentage increment rate applied to each successive unit bet of the wager.

In the hardware embodiment of one option of the invention, apparatus may be included at each player position of the gaming table to detect a primary wager within the primary game betting circle and to determine the value of that wager. In prior art systems, one method used is an embedded RF-ID tag in the gaming chip, and an associated RF-ID antenna and transceiver system embedded into the table in such a configuration that each wager within each primary wager circle can be measured independently. In such an option, the system may measure not only the value of the primary wager, but also detect the denomination, or combination of denominations. In so doing, the system may use not only the value of the wager, but also the denomination of the wager to support systems employing a mixed system, partially overlapping progressive jackpot system as discussed in an earlier section of the present invention.

Alternatively or additionally, the table based progressive jackpot system may support player card readers, whereas the player inserts his or her card to establish to the system the rank, or player rating, of each player. The progressive system can optionally use the player rank, or player rating, as an additional attribute in determining the overall rank of the wager combination. This additional component of the wager can be used to establish a multi-axis rate multiplier scale, as previously discussed for partially overlapped, mixed multi-coin and multi-denomination progressive system. This additional wager attribute creates an additional tier of jackpot eligibility, whereas players having greater player rank can play for larger jackpots. These larger jackpots are in part funded by side wager contributions from like players.

While new technologies, such as embedded RF-ID tags in casino gaming chips, could simplify the process of detecting and measuring a table game wager, other methods are available to accomplish the same objective. For example, in one optional embodiment, a camera is located under the table next to each primary wager betting circle, one camera for each betting circle. In one option, the wager circle is transparent, such that the camera may view all chips within the circle. The camera is so positioned to view the stack of gaming chips from the side. A computer system is connected to each camera to process the image of the stack of gaming chips. Software is employed to measure the image of the stack of gaming chips, and determine the value, and even the denomination, of the wager at each betting circle. The image may be analyzed for color of the gaming chips, number of gaming chips, and/or symbols and bars located on the side of the gaming chips to establish the value and/or denomination of the wager. In another option, a single camera is placed in such a position as to view all betting circles of the entire table game. Again, a computer is employed to analyze the image of the chips at each betting circle, either upon the lock-out process, or just before the lock-out process. The image of the gaming chips at each betting circle is analyzed and measured to determine the value, and even the denomination, of each wager within each betting circle.

Other options for hardware embodiment are available for accomplishing equivalent objectives for measuring the value of a wager placed within a betting circle. In one option, the table game supports “virtual chips”. The virtual chips are essentially computer images of gaming chips displayed at each betting circle, or at each player position. Each player controls the value of his or her respective wager by using a credit button located at each player position. By controlling the credit button, or buttons, the player can set the desired wager level for the primary game at hand. The credit button can establish the value of each wager that is subsequently owed the casino if the player loses, or debits from an account that has been pre-established with the casino by each player, or debits from a credit meter account that has been established by depositing coupons, cash or gaming chips into an associated acceptor unit by the player at each player position. In a like manner, if the player wins the primary game hand, the virtual chips can be appropriately added to, or the winning payment can be made to the players account, credit meter, or cashed out in the form of coupons, chips, cash or other monetary device. That is, a computer system is employed at the gaming table which detects the wager placed by each player via credit button activation, tracks such wagers, and measures the value and even the denomination of each wager placed by each player. Using this information, the system can adequately measure the wager from each player to perform the necessary tasks of determining the progressive increment.

Regardless of the method used to measure the value of the wager within the betting circle, either method accomplishes the same objective for the operation of the progressive system as defined herein.

In one option of the present invention, a side wager is not used to fund the progressive contribution. Instead, the progressive contribution is derived as a percentage of the primary game wager itself. This is similar to the strategy for most electronic gaming machines, where the game payback is adjusted to allow the progressive contribution to be funded directly from the primary game wager. In such a case, a side wager betting circle is no longer required. However, the system can detect and measure the value of the primary wager automatically in order to simplify the task of tracking and allocating the progressive contribution as the game is played. In this option, any of the available techniques to measure the value of the wager within the primary betting circle can be used. In a similar manner, the progressive contribution for each unit bet of each wager is made in accordance to the methods set forth for multi-coin and multi-denomination progressives of the present invention.

Once an eligible player hits a progressive jackpot, the jackpot is awarded to the player. The task of activating the jackpot could vary. In one optional embodiment, the dealer position utilizes a key-pad or button console. The button console optionally supports a jackpot key-switch, and jackpot activation buttons. In such an example embodiment, when a player hits the progressive jackpot, the dealer calls over the pit boss for secondary verification that the player did indeed receive the winning game combination required to receive the progressive jackpot. Upon verification, the pit boss may activate the jackpot award process by inserting a key into the jackpot key-switch located at the dealer position. The dealer or pit boss activates the jackpot award button associated to the winning combination (since more than one progressive group may be supported). The system detects the jackpot award activation and activates a display at the table, or at the player position indicating the value of the progressive jackpot to be paid. The system calculates the value of the jackpot in accordance to the level of the primary game wager made prior to the start of the round or hand. The jackpot system resets the progressive jackpot in accordance to the method of the present invention discussed earlier. The casino pays the player their entitled jackpot award amount. The new progressive (reset) progressive jackpot value(s) and overall progressive jackpot pool can be displayed on any and all progressive jackpot displays supported in the link by the system.

In another option of the invention, an automatic progressive award detection feature is supported. In one option, a camera is employed either in the card shoe, or during the card shuffling process. The camera is used to record the rank and value of each card as it is dealt to each player during each round of play. By employing software to track the value of each card dealt to each player, the system can recognize the occurrence of a progressive jackpot hit, or winning card combination. Once the system detects a winning card combination, the system can indicate so, and instruct or signal to the dealer to hold the game until the winning card combination can be verified, for example. In this case, the table based progressive system can immediately freeze the jackpot value into the memory, thereby eliminating possible progressive jackpot race states that might be encountered in a manual jackpot activation process, such as when using jackpot activation buttons.

Actual payment to the player may be made manually, using gaming chips, or made automatically. In one option, progressive jackpot payment can be dispensed as a payment coupon to the player, or automatically deposited into a player account, or player credit meter.

Because the number of wager levels may be large in a table game application, various methods can be employed to inform the player as to the value of the progressive jackpot he or she is entitled to for each level of wager placed. For example, in one option, a high resolution display is supported at the table, or directly behind the table in full view of all player positions. The high resolution display is optionally a plasma type display monitor, an LCD display monitor, or other suitable display technology. The high-resolution display shows the value of the progressive jackpot to be awarded for each level of wager placed on the primary game. In one option, the overall progressive jackpot pool is also displayed, indicating the maximum value of the progressive jackpot eligible to those placing a maximum size wager.

In one option of the present invention, a display is supported at each player position that displays the value of the progressive jackpot to be awarded to that player corresponding to the value of wager currently being placed on the primary game. The progressive value displayed to each player can change in accordance to the value of the wager being placed on the primary game. This informs the player as to what progressive sub-level they are eligible for as they adjust the size of their primary game wager. In such an optional embodiment, the value of each jackpot displayed is actually a summation of each virtual pool associated to each unit bet of the particular wager being placed in accordance to the methods of multi-coin and multi-denomination progressive system of the present invention.

A terminal contribution rate can be defined for table based progressive systems. As defined earlier, the terminal contribution rate defines a maximum sized wager for which no additional virtual pools are managed or supported. In the event a wager is made in excess of the so-called maximum wager limit, the player is entitled to the entire jackpot pool, while the increment rate for any value of the wager in excess of the maximum size wager may contribute a fixed percentage to the last virtual pool, VPn, either using rate multiplier RMn, or some other fixed terminal contribution rate. This allows the table based progressive system to support wagers of unlimited size, yet allows the table based progressive system to establish a terminal contribution rate at a wager level that is likely to be awarded at some point. Otherwise, the possibility of a progressive jackpot pool that is not likely to ever be awarded may result.

In a manner similar to that explained earlier for multi-coin and multi-denomination progressives, the plurality of rate multipliers for the table based progressive system can be adjusted to satisfy a proportional system. Rate multipliers may be adjusted to achieve specific objectives. For example, if the rate multipliers are adjusted to establish a proportional progressive jackpot system, players will be enticed, on average, to place larger wagers because players placing larger wagers will, on average, receive a larger proportion of the overall jackpot pool. In any event, players are always entitled to a fair share of the progressive pool regardless of the value of rate multipliers. Rate multipliers can be adjusted to achieve specific objectives in terms of progressive jackpot growth relative to each size of wager placed on the primary game.

1. A method for controlling one or more progressive jackpot pools for a game in which wagers of various sizes or denominations may be placed, the game generating a plurality of game outcomes, at least one of which results in a progressive payout trigger, comprising:
defining two or more wager levels;
subdividing said progressive jackpot pool into two or more virtual progressive pools;
associating each virtual progressive pool with a wager level;
receiving a wager for play of said game;
allocating a portion of said wager to the virtual progressive pool associated to the wager level of said wager and allocating a portion of said wager to at least one virtual progressive pool associated with a lesser wager level, if any; and
in response to said progressive payout trigger, issuing a progressive award equal to the sum of the virtual progressive pools associated with the wager level and each lesser wager level, if any, to which the wager placed at the time of the progressive payout trigger was allocated.

2. The method of claim 1 wherein each said progressive jackpot pool is associated to a specific winning game outcome.

3. The method of claim 2 wherein the progressive payout trigger is unique for each winning game outcome, the progressive payout trigger being actuated during play of a game resulting in a winning game outcome associated with said wager level.

4. The method of claim 1 wherein said wager level represents a coin multiple level.

5. The method of claim 1 wherein said wager level represents a wager denomination level.

6. The method of claim 1 further comprising defining a terminal wager level representing the smallest wager level allocating a greater portion of said wager to said progressive pool than any other wager level.

7. The method of claim 1 further comprising resetting each virtual progressive pool summed for said progressive award to a base value.

8. The method of claim 1 wherein said allocation to a virtual progressive pool varies with the wager level associated with the virtual progressive pool.

9. The method of claim 1 further comprising defining a multiplier for each wager level wherein said contribution to each virtual progressive pool is proportional to the multiplier of said virtual progressive pool.

10. A method for controlling one or more progressive awards in at least one gaming machine for a game in which wagers of varying wager levels may be placed, said gaming machine generating a plurality of game outcomes, at least one of which results in a progressive payout trigger, comprising:
defining two or more wager levels and establishing a hierarchy among said wager levels;
establishing at least one progressive jackpot pool and associating said progressive jackpot pool to at least one game outcome;
subdividing said progressive jackpot pool into two or more virtual progressive pools;
associating each virtual progressive pool with a wager level;
defining a plurality of progressive awards each associated to a specific wager level representing the sum of the virtual pool associated to said wager level and all other virtual pools associated to lesser wager levels in said hierarchy;
detecting a wager for play of said game;
for each wager detected, adding a contribution into each virtual pool associated with the wager level of the wager detected and all lesser wager levels in said hierarchy; and
in response to said progressive payout trigger, issuing the progressive award associated with the wager level of the wager resulting in the progressive payout trigger.

11. The method of claim 10 wherein said wager level represents a coin multiple level.

12. The method of claim 10 wherein said wager level represents a wager denomination level.

13. The method of claim 1 further comprising defining a terminal wager level representing the smallest wager level allocating a greater portion of said wager to said progressive pool than any other wager level.

14. The method of claim 10 further comprising resetting each virtual progressive pool summed for said progressive award to a base value.

15. The method of claim 10 wherein said contribution to a virtual progressive pool varies with the wager level associated with the virtual progressive pool.

16. The method of claim 10 further comprising defining a multiplier for each virtual pool and said contribution to the progressive pool is proportional to the sum of the multipliers for the first wager level through the wager level associated with said game play wager, in said wager hierarchy.

17. The method of claim 10 wherein said gaming machine is linked to a system of linked gaming machines.

18. A method for controlling and displaying at least two progressive awards for a gaming machine for a game in which wagers of varying wager levels may be placed, each gaming machine generating a plurality of game outcomes, at least one of which results in a progressive payout trigger, comprising:
defining two or more wager levels and establishing a hierarchy among said wager levels;
establishing at least two virtual progressive pools and associating each virtual progressive pool with a wager level;
establishing at least two progressive awards, each progressive award associated with a wager level wherein each progressive award is defined as the sum of each virtual pool associated with said wager level and at least one lesser wager level, if any;
detecting the wager level for each wager placed before initiating said game;
in response to each wager placed before each game, displaying the progressive award associated with said detected wager level;
detecting the wager level for a wagered amount for play of said game;
allocating a portion of said wagered amount to each virtual progressive pool associated with the wager level of a wagered amount detected and at least one lesser wager level, if any; and
in response to said progressive payout trigger, issuing the progressive award associated with the wager level of the wager resulting in the progressive payout trigger.

19. The method of claim 18 wherein said unit wager represents a multiple coin wager level.

20. The method of claim 18 wherein said unit wager represents a wager denomination level.

21. The method of claim 18 further comprising defining a terminal wager level representing the smallest wager level contributing the greatest portion of said wager to said progressive pool.

22. The method of claim 18 further comprising resetting each virtual progressive pool summed for said progressive award to a base value.

23. The method of claim 18 wherein said contribution to a virtual progressive pool varies with the wager level associated with the virtual progressive pool.

24. The method of claim 18 further comprising defining a multiplier for each wager level wherein said contribution to each virtual progressive pool is proportional to the multiplier of said virtual progressive pool.

25. A method for controlling one or more progressive jackpot pools for a game allowing two or more possible wager combinations of wager units and denominations, the game generating a plurality of game outcomes, at least one of which results in a progressive payout trigger, comprising:
ranking each wager combination with respect to each other, said ranking a function of one or more of units wagered and denominations wagered;
defining at least two virtual progressive pools and associating each said virtual progressive pool with a wager combination rank;
defining a plurality of rate multipliers, each said rate multiplier associated with a virtual pool;
detecting a wager;
adding a contribution to each virtual pool associated with a wager combination of equal or lesser rank to the wager in direct proportion to the rate multiplier associated with said virtual pool;
defining a plurality of progressive jackpot awards, each said progressive jackpot award associated to a wager combination, and each said progressive jackpot award is defined as the sum of all virtual pools associated with wager combinations of equal or lesser rank to the wager; and
paying the progressive jackpot award associated to the wager combination resulting in a game outcome causing a progressive payout trigger.

26. The method of claim 25 further comprising resetting each virtual progressive pool summed for said progressive award to a base value.

27. A method for controlling one or more progressive awards for a game allowing two or more possible primary wager amounts and an optional side wager, the game generating a plurality of game outcomes, at least one of which results in a progressive payout trigger, comprising:
defining two or more virtual pools;
associating each virtual pool to a possible primary wager amount;
detecting a primary wager to prompt game play;
detecting a side wager;
allocating a portion of said side wager to the virtual pool associated with said primary wager mount and allocating a portion of said side wager to at least one virtual pool associated with a primary wager amount of lesser value, if any; and
in response to said progressive payout trigger, issuing a progressive award equal to the sum of all virtual pools associated with the primary wager amount resulting in the progressive payout trigger and each primary wager amount of lesser value, if any.

28. The method of claim 27 wherein said step of associating each virtual pool to a possible primary wager amount further includes associating each virtual pool to a range of possible primary wager amounts.

29. The method of claim 27 further comprising resetting each virtual progressive pool summed for said progressive award to a base value thereby resulting in the subtraction of said progressive award from said progressive jackpot pool.

30. A method for controlling one or more progressive jackpot pools for a game in which primary wagers of various sizes or denominations may be placed and in which one or more optional side wagers may be placed, the game generating a plurality of game outcomes, at least one of which results in a progressive payout trigger, comprising:
defining two or more primary wager levels;
defining one or more side wager options and associating each side wager option to a progressive jackpot pool;
subdividing each progressive jackpot pool into two or more virtual progressive pools;
associating primary wager levels to specific virtual progressive pools;
detecting the size of the primary wager to prompt play;
detecting any side wager;
for each side wager detected, allocating a portion to all virtual pools associated with said primary wager level associated with said primary wager and all lesser primary wager levels; and
in response to said progressive payout trigger, issuing a progressive award equal to the sum of the virtual pools associated with the primary wager level associated with the primary wager resulting in the progressive payout trigger and all virtual pools associated to lesser primary wager levels.

31. The method of claim 30 further comprising resetting each virtual progressive pool summed for said progressive award to a base value thereby resulting in the subtraction of said progressive award from said progressive jackpot pool.
